(19) United States
(12) Patent Application Publication
(10) Pub. No.: US 2026/0099036 A1
(43) Pub. Date: Apr. 9, 2026

(54) IMAGING LENS AND IMAGING DEVICE

(71) Applicant: GUANGDONG OPPO MOBILE TELECOMMUNICATIONS CORP., LTD., Dongguan (CN)

(72) Inventor: Tatsuya NAKATSUJI, Nishi-ku (JP)

(21) Appl. No.: 19/417,287

(22) Filed: Dec. 11, 2025

Related U.S. Application Data
(63) Continuation of application No. PCT/CN2023/124332, filed on Oct. 12, 2023.

(51) Int. Cl. G02B 13/00; G02B 9/34; G02B 9/60; G02B 17/00; G03B 17/17

(52) U.S. Cl. CPC G02B 13/0065; G02B 9/34; G02B 9/60; G02B 13/0045; G02B 17/006; G03B 17/17

(57) ABSTRACT

An imaging lens and an imaging device are provided. The imaging device according to one aspect of the present application includes an imaging element and an imaging lens. The imaging lens includes a lens group and a reflective light guide element having reflecting surfaces. The imaging lens is configured to enable light passing through the lens group to emit toward an imaging element after having n reflections on the reflecting surfaces, and n is an integer of 5 or more.

### CROSS-REFERENCE TO RELATED APPLICATIONS

This application is a continuation of International Patent Application No. PCT/CN2023/124332, filed Oct. 12, 2023, the entire disclosure of which is incorporated herein by reference.

### TECHNICAL FIELD

The present disclosure relates to an imaging lens and an imaging device.

### BACKGROUND

Conventionally, a wide-angle single focus lens mounted on a smartphone extends the entire lens in a thickness direction of a body of the smartphone to perform a focus. A method of moving the lens in the thickness direction of the body of the smartphone is advantageous for thinning the body of the smartphone. A telephoto lens may employ a periscope method due to a long focal length, but the periscope method is to determine the thickness of the body of the smartphone in the thickness direction by the size of the short side of the sensor or F-number of the lens, and thus a telephoto lens with a large sensor size and a small F-number is disadvantageous for thinning the body of the smartphone.

Moreover, when trying to reduce the thickness of the body of the smartphone with the periscope method, the lens may use a lens obtained by partly cutting the shape of the lens from a circular shape. However, in this case, because the molding manufacturing of the plastic lens and the eccentricity adjustment by the lens rotation when installing the lens are impossible, a yield ratio of the lens is deteriorated.

### SUMMARY OF THE DISCLOSURE

An imaging lens according to one aspect of the present disclosure includes a lens group including at least one lens having optical power and a reflective light guide element having reflecting surfaces. The imaging lens is configured to enable light passing through the lens group to emit toward an imaging element after having n reflections on the reflecting surfaces, and n is an integer of 5 or more.

An imaging device according to another aspect of the present disclosure includes an imaging element and an imaging lens. The imaging lens includes a lens group including at least one lens having optical power and a reflective light guide element having reflecting surfaces. The imaging lens is configured to enable light passing through the lens group to emit toward the imaging element after having n reflections on the reflecting surfaces, and n is an integer of 5 or more. The imaging element is configured to capture an image of an object via the imaging lens.

### BRIEF DESCRIPTION OF THE DRAWINGS

FIG. 1 is an outline explanatory diagram illustrating a configuration of an imaging lens according to a first embodiment.

FIG. 2 is an explanatory diagram for providing a margin.

FIG. 3A is an aberration diagram illustrating an astigmatism of the imaging lens according to Example 1.

FIG. 3B is an aberration diagram illustrating a spherical aberration of the imaging lens according to Example 1.

FIG. 3C is an aberration diagram illustrating a distortion aberration of the imaging lens according to Example 1.

FIG. 3D is an aberration diagram illustrating a chromatic aberration of magnification of the imaging lens according to Example 1.

FIG. 4 is a diagram explaining a configuration of an imaging lens according to Example 2.

FIG. 5A is an aberration diagram illustrating an astigmatism of the imaging lens according to Example 2.

FIG. 5B is an aberration diagram illustrating a spherical aberration of the imaging lens according to Example 2.

FIG. 5C is an aberration diagram illustrating a distortion aberration of the imaging lens according to Example 2.

FIG. 5D is an aberration diagram illustrating a chromatic aberration of magnification of the imaging lens according to Example 2.

FIG. 6 is a diagram explaining a configuration of an imaging lens according to Example 3.

FIG. 7A is an aberration diagram illustrating an astigmatism of the imaging lens according to Example 3.

FIG. 7B is an aberration diagram illustrating a spherical aberration of the imaging lens according to Example 3.

FIG. 7C is an aberration diagram illustrating a distortion aberration of the imaging lens according to Example 3.

FIG. 7D is an aberration diagram illustrating a chromatic aberration of magnification of the imaging lens according to Example 3.

FIG. 8 is a diagram illustrating an example of optical paths of effective rays and optical paths of ghost light.

FIG. 9 is a diagram illustrating an example of a method for cutting the ghost light.

FIG. 10 is a diagram explaining a principle that the ghost light is cut from the effective rays.

FIG. 11 is a diagram illustrating the imaging lens illustrated in FIG. 9 in a different display format.

FIG. 12A is an aberration diagram illustrating an astigmatism of the imaging lens according to Example 4.

FIG. 12B is an aberration diagram illustrating a spherical aberration of the imaging lens according to Example 4.

FIG. 12C is an aberration diagram illustrating a distortion aberration of the imaging lens according to Example 4.

FIG. 12D is an aberration diagram illustrating a chromatic aberration of magnification of the imaging lens according to Example 4.

FIG. 13 is a diagram explaining an example of optical functional parts that can be configured as a reflective light guide element.

FIG. 14A is a diagram illustrating an example of wavelength characteristic of a reflectance of a low-reflection black absorption film.

FIG. 14B is an explanatory diagram illustrating a black absorbing coating to be applied around an aluminum-enhanced reflection film.

FIG. 15 is a diagram explaining wavelength characteristic of a reflectance of an incidence dependent film.

FIG. 16 is a diagram illustrating an example of a configuration of an imaging device according to a second embodiment.

FIG. 17 is a diagram illustrating an example of a configuration of a camera of a camera part.

FIG. 18 is a diagram illustrating an example of a form of a bi-fold smartphone.

FIG. 19 is a diagram illustrating a mounting example of an imaging lens.

FIG. 20 is a diagram illustrating an example of the imaging lens having a configuration that a value of “P_margin” is negative.

FIG. 21 is a diagram illustrating an example of a configuration of a smartphone mounted with a periscope lens.

### DETAILED DESCRIPTION

When mounting a telephoto lens, a method of bending the light incident in the thickness direction of the body of the smartphone with a reflecting surface to increase an optical length is advantageous for thinning the body of the smartphone. However, conventionally, when the number of reflections on one reflective light guide element increases, another reflective light guide element is added to an optical system when further increasing the number of reflections. For this reason, it is difficult to thin the thickness of the body of the smartphone as the number of reflections increases.

The present disclosure has been made in view of the above-described problem, and an object of the present disclosure is to provide an imaging lens and an imaging device, which can use the same reflective light guide element even if the number of reflections increases.

Hereinafter, an imaging lens and an imaging device according to embodiments will be described in detail with reference to the accompanying drawings. Note that the present invention is not limited to the embodiments.

### EMBODIMENTS

### First Embodiment

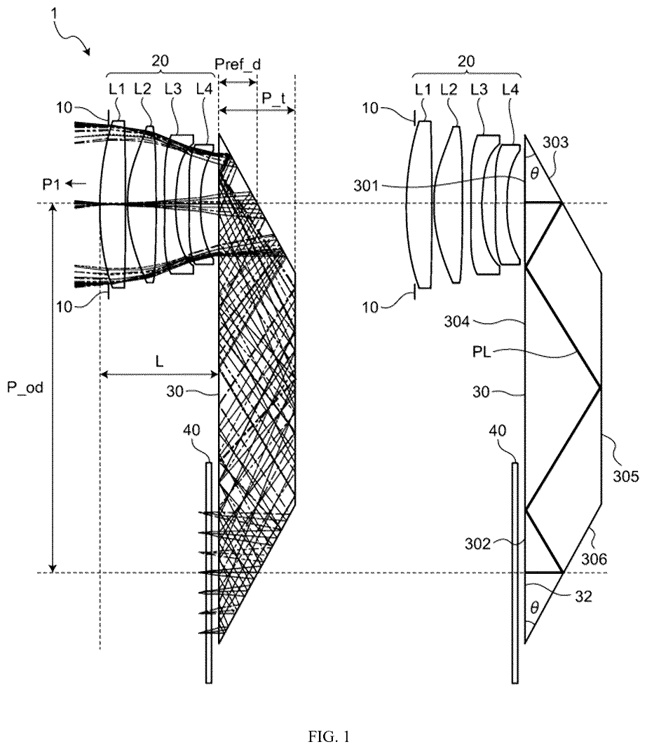

FIG. 1 is an outline explanatory diagram illustrating a configuration of an imaging lens 1 according to a first embodiment. The configuration of the imaging lens 1 illustrated in FIG. 1 is an example for the brief description. In FIG. 1, the left is a diagram obtained by superimposing optical paths of a principal ray, an upper ray, and a lower ray on the imaging lens 1, and the right is a diagram illustrating an optical path in a reflective light guide element 30 of a ray to pass on a lens optical axis among ray optical paths illustrated on the imaging lens 1. Moreover, parameters of the imaging lens 1 are attached to each drawing illustrated in FIG. 1. The parameters of each drawing illustrated in FIG. 1 will be collectively described later.

First, the brief of a configuration of an imaging lens with five reflections will be described by using the imaging lens 1 illustrated in FIG. 1. Hereinafter, note that a case where the description is performed by using the imaging lens 1 illustrated in the right side of FIG. 1 is marked as a right diagram and a case where the description is performed by using the imaging lens 1 illustrated in the left is marked as a left diagram. When any of the right diagram and the left diagram is not marked, any of the right diagram and the left diagram may be referred.

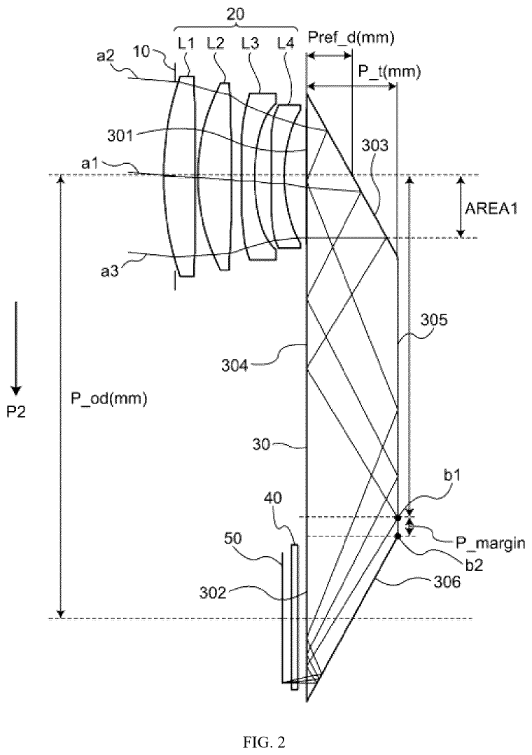

The imaging lens 1 includes a diaphragm 10, a lens group 20, and the reflective light guide element 30. The light from an object side passes through the diaphragm 10, the lens group 20, and the reflective light guide element 30 in this order. The light passing through the reflective light guide element 30 is emitted toward an IR filter 40. An imaging element (imaging element 50 illustrated in FIG. 2) not illustrated in FIG. 1 is arranged to the IR filter 40 side.

Note that the imaging lens 1 may include, in addition to the diaphragm 10, the lens group 20, and the reflective light guide element 30, a color correction member such as the IR filter 40 illustrated in FIG. 1 and another optical element.

### Configuration of Lens Group

Hereinafter, a first lens, a second lens, a third lens, a fourth lens, etc. are respectively referred to as a first lens L1, a second lens L2, a third lens L3, a fourth lens L4, etc. In the drawings and tables, symbols of L1, L2, L3, and L4 are respectively added to elements corresponding to these lenses.

The lens group 20 illustrated in FIG. 1 is a lens group with a four-piece configuration for one group having the first lens L1, the second lens L2, the third lens L3, and the fourth lens L4 in order from the object side. Herein, the first lens L1 corresponds to “a lens through which the light from the object side passes first”, and the fourth lens L4 corresponds to “a lens through which the light from the object side passes finally” because the lens group 20 has a four-piece configuration for one group. Note that “the final lens” is a fifth lens L5 in the case of a five-piece configuration and “the final lens” is a sixth lens L6 in the case of a six-piece configuration.

The configuration of the imaging lens 1 illustrated in FIG. 1 is an example that the lens group 20 has a four-piece configuration, but the imaging lens 1 has the same configuration as the configuration to be described below even if the lens group 20 has a configuration other than a four-piece configuration, such as a five-piece configuration and a six-piece configuration.

The lens group 20 includes at least one lens having positive optical power and at least one lens having negative optical power. In the configuration of the imaging lens 1 illustrated in FIG. 1, the first lens L1 and the second lens L2 are lenses having positive optical power, and the third lens L3 and the fourth lens L4 are lenses having negative optical power.

### Configuration of Reflective Light Guide Element

The reflective light guide element 30 guides rays incident from an incident surface 301 of the reflective light guide element 30 to an exit surface 302 of the reflective light guide element 30. The contour of the reflective light guide element 30 illustrated in FIG. 1 is an example. A portion of the contour of the reflective light guide element 30 has a configuration that the incident rays are reflected inside.

The reflective light guide element 30 illustrated in FIG. 1 is a prism with five-reflection design. A first slope 303, a first plane 304, a second plane 305, and a second slope 306 are provided at an angle at which the incident rays are totally reflected. For example, a ray on the lens optical axis incident from the incident surface 301 is totally reflected in the order of the first slope 303, the first plane 304, the second plane 305, the first plane 304, and the second slope 306, as illustrated in the right diagram of FIG. 1. The ray totally reflected for the fifth time is emitted toward the IR filter 40 from the exit surface 302 of the reflective light guide element 30.

Note that, when using an optical system having a long focal length in which the optical length inside the reflective light guide element 30 is extended, the reflective light guide element 30 may have six reflections or more without being limited to five reflections.

In the case of six reflections, the first plane 304 and the second plane 305 are further extended, and the second slope 306 becomes parallel to the first slope 303 because the number of reflections is changed to even reflections. In this case, the IR filter 40 is arranged to the second plane 305 side, and the rays are emitted toward the second plane 305. In this case, the imaging element (the imaging element 50 illustrated in FIG. 2) is also arranged to the second plane 305 side.

In the case of seven reflections, the first plane 304 and the second plane 305 are further extended, and the second slope 306 becomes parallel to the second slope 306 illustrated in FIG. 1 because the number of reflections is the same odd reflections as five reflections. In this case, similar to the arrangement illustrated in FIG. 1, the IR filter 40 is arranged to the first plane 304 side, and the rays are emitted toward the first plane 304. In this case, the imaging element (the imaging element 50 illustrated in FIG. 2) is also arranged to the first plane 304 side.

After that, depending on the number of reflections, the first plane 304 and the second plane 305 are extended as appropriate, and the second slope 306 is also arranged in a corresponding direction in accordance with the odd number of reflections or the even number of reflections. Therefore, it may be said that the reflective light guide element with the n-reflection configuration emits light after n reflections to a sensor surface of an imaging element that is arranged to the reflecting surface side on which the (n−1)th reflection is performed.

Because the following explanation for the reflective light guide element 30 is made by using the odd-reflection configuration illustrated in FIG. 1 as an example, the incident surface and the exit surface are located on the same first plane.

In the contour of the reflective light guide element 30 illustrated in FIG. 1, the incident surface 301 and the exit surface 302 together correspond to the same first plane. Inside the first plane, an area that becomes the incident surface 301 and an area that becomes the exit surface 302 are different from each other. The first plane including the incident surface 301 and the exit surface 302 functions as a reflecting surface when rays are incident at an angle of total reflection inside the reflective light guide element 30.

The incident surface 301 in the configuration illustrated in FIG. 1 totally reflects, among the rays reflected from the first slope 303, incident rays whose incident angle is a predetermined angle or more. The exit surface 302 totally reflects, among the rays reflected from the second plane 305, incident rays whose incident angle is a predetermined angle or more toward the second slope 306. The predetermined angle means an incident angle that satisfies an angle of total reflection. Note that, in the case of the even-reflection configuration, the exit surface totally reflects incident rays whose incident angle is a predetermined angle or more toward the second slope 306.

Herein, the first slope 303, the first plane 304, the second plane 305, and the second slope 306 are examples of “reflecting surfaces”.

Note that, when there is a surface that does not satisfy an angle at which the effective rays are totally reflected among the “reflecting surfaces” such as the first slope 303, the first plane 304, the second plane 305, and the second slope 306, reflective material may be applied on a target surface etc. excluding the incident surface 301 and the exit surface 302 to reflect the rays. For example, metal reflective coating such as a metal enhanced reflection film is applied by metal vapor deposition. As an example, the metal reflective coating is aluminum reflective coating such as an aluminum metal enhanced reflection film.

Moreover, a configuration of increasing a reflectance of effective rays and removing or reducing rays other than the effective rays may be employed by providing a dichroic reflecting mirror on the reflecting surface if needed to change a reflectance in accordance with the incident angle of rays.

The detailed explanation for the aluminum reflective coating and the dichroic reflecting mirror will be described later.

### Other Configuration

The IR filter 40 is an example of a color correction member to perform infrared absorption. The color correction member may be changed to a member that performs another color correction as appropriate, without being limited to infrared absorption.

The lens group 20 of the imaging lens 1 may have a configuration that the lens group is driven by a driving means such as VCM (voice coil motor) and is mechanically extended in a thickness direction P1 of the body of the imaging device.

With the configuration that the exit surface 302 of the reflective light guide element 30 is located on the same first plane as the incident surface 301 of the reflective light guide element 30 as illustrated in FIG. 1, the IR filter 40 and the imaging element (the imaging element 50 illustrated in FIG. 2) not illustrated in FIG. 1 are together arranged to the same plane as the incident surface 301 to face each other. Note that, because the exit surface is located on the second plane in the even-reflection configuration, the IR filter 40 and the imaging element (the imaging element 50 illustrated in FIG. 2) are arranged to the second plane to face each other.

The imaging element includes a plurality of pixels arranged in a two-dimensional array, and photo-electrically converts the light from the object and outputs a pixel signal. The imaging element 50 is an image sensor, such as CCD (Charge Coupled Device) and CMOS (Complementary Metal-Oxide-Semiconductor), which captures an image of the object.

### Explanation for Parameters

Next, parameters for the imaging lens 1 illustrated in FIG. 1 will be described. Note that, even when the lens configuration employs a lens configuration different from the lens configuration illustrated in the lens group 20 of FIG. 1, the configurations have common parameters if the configurations have common elements.

First, parameters illustrated in the left diagram of FIG. 1 will be described. “P_od” is a parameter indicating a distance between optical axes of the optical axis of the lens group 20 and the optical axis of the emitted rays along which light on the optical axis is emitted from the reflective light guide element 30 to the imaging element. A unit of P_od is a millimeter (mm). “L” is a parameter indicating a distance from the lens vertex of the first lens L1 to the reflective light guide element 30. “Pref_d” is a parameter indicating a distance from the incident surface 301 of the reflective light guide element 30 to an intersection point where the lens optical axis intersects with the first slope 303. Herein, the lens optical axis means an optical axis at the center of the lens in the lens group 20. A unit of Pref_d is a millimeter (mm). “P_t” is a parameter indicating a thickness of the reflective light guide element 30 in the lens optical axis direction. A unit of P tis a millimeter (mm).

Next, parameters illustrated in the right diagram of FIG. 1 will be described. “0” is a parameter indicating an angle between the incident surface 301 and the slope surface of the first slope 303 in the reflective light guide element 30. In the contour illustrated as an example of the reflective light guide element 30 in FIG. 1, an angle between the exit surface 302 and the slope surface of the second slope 306 in the reflective light guide element 30 is also 0, and these values of 0 is the same. Note that, because the exit surface is located on the second plane in the even-reflection configuration, an angle between the second plane and the slope surface of the second slope 306 parallel to the first slope 303 illustrated in FIG. 1 is 0. A unit of 0 is deg (degree). “PL” is an optical length within the reflective light guide element 30 of the rays to pass on the lens optical axis.

Moreover, hereinafter, “EFL” is a focal length of the entire lens. “dd” is a parameter indicating a half size of the sensor surface of the imaging element in the diagonal direction. “EPD” is an exit pupil diameter. “P_margin” is a parameter indicating a margin to be described later. “f_F” is a focal length (composite focal length) of front lenses other than rear two lenses in the lens configuration included in the lens group 20. “f_B2” is a focal length (composite focal length) of the rear two lenses in the lens configuration included in the lens group 20.

### Optical Setting Conditions

The inventor has performed optical simulation with various settings, and has obtained particularly effective optical setting conditions in the design with five or more reflections.

$$4 < EFL / dd \qquad ( Condition 1 )$$

$$EPD / PL < 0.24 \qquad ( Condition 2 )$$

$$P\_margin = PL\_ 1 - PL\_ {2}^{′} > 0 \qquad ( Condition 3 )$$

$$f\_F > 0 \qquad ( Condition 4 )$$

$$f\_B 2 < 0 \qquad ( Condition 5 )$$

$$- 1.5 < f\_B2 / f\_F < - 0.5 \qquad ( Condition 6 )$$

$$L > P\_t \qquad ( Condition 7 )$$

$$EPD / Pref\_d < 3.25 \qquad ( Condition 8 )$$

Condition 1 is a condition for establishing five or more reflections with a telephoto lens system.

Condition 2 is a condition for appropriately setting an optical length.

Condition 3 is a condition for providing a margin in the reflective light guide element 30. A margin will be described in detail below with reference to FIG. 2.

Condition 4 is a condition for making front lenses other than rear two lenses have positive optical power.

Condition 5 is a condition for making the rear two lenses have negative optical power.

Condition 6 is a condition for constraining a ratio of a focal length. If it is within this range, it is possible to extend the back to take setting favorable to five or more reflections.

Condition 7 is a condition for thinning the thickness of the reflective light guide element 30 more than the thickness of the lens group 20 in the lens optical axis direction.

Condition 8 is a condition of the distance Pref_d for increasing the optical length.

### Explanation for Margin of Condition 3

Next, a margin in the reflective light guide element 30 having five or more reflections will be described. When manufacturing the reflective light guide element 30 having five or more reflections, a margin to be explained below is provided.

FIG. 2 is an explanatory diagram for providing a margin. In the imaging lens 1 illustrated in FIG. 2, among the incident rays on the imaging lens 1 illustrated in the left diagram of FIG. 1, a principal ray a1, an upper ray a2, and a lower ray a3 of the ray bundle collected at farthest positions from the lens optical axis in the P2 direction of FIG. 2 to form an image on the sensor surface of the imaging element 50 are illustrated. The lower ray a3 means, among the rays of the ray bundle, a ray passing through the lens group 20 on the imaging element 50 side, and corresponds to “a first ray”.

As illustrated in FIG. 2, with the five-reflection configuration, a margin is provided, inside the reflective light guide element 30, between a position b1 where the lower ray a3 is the third reflection and a surface on which the fifth reflection is performed, that is, between a position on the surface of the second plane 305 and a boundary b2 between the surface of the second plane 305 and the surface of the second slope 306. In FIG. 2, the parameter P_margin is added to a place where a margin is provided. Furthermore, a parameter AREA is added for explanation of a margin. “P_margin” is a parameter indicating a numerical value of the margin.

The following Expression (1) and Expression (2) are exemplary expressions when the parameter P_margin of the margin illustrated in the imaging lens 1 of FIG. 2 is mathematized and is generalized for the configuration having five or more reflections. In this regard, however, “n” is the number of reflections inside the reflective light guide element, and is an integer of 5 or more.

### <Expression (1)>

Expression (1) is an expression when the lower ray a3 is incident parallel to the lens optical axis.

$$AREA 1 = ( EPD / 2 ) / LTL * ( LTL - L )$$

$$PL\_ 2 = AREA 1 + P\_t * TAN ( θ * 2 ) * ( n - 4 ) + ( AREA 1 * TAN θ + Pref\_d ) * TAN ( 2 * θ )$$

### <Expression (2)>

Actually, because the lower ray a3 does not become parallel to the lens optical axis, Expression (2) obtained by applying Expression (1) in accordance with the deviation of the incident angle of the lower ray a3 is applied. As an example, the following Expression 2 that is an expression when the deviation of the incident angle is 1°.

$$AREA 1 = ( EPD / 2 ) / LTL * ( LTL - L )$$

$$PL\_ {2}^{′} = AREA 1 + P\_t * TAN ( ( θ + 1 ) * 2 ) * ( n - 4 ) + ( AREA 1 * TAN ( θ + 1 ) + Pref\_d ) * TAN ( 2 * ( θ + 1 ) )$$

### <Conditions>

When the reflective light guide element 30 on which five or more reflections are performed is actually manufactured, the following condition is satisfied.

$$P\_margin = PL\_ 1 - PL\_ {2}^{′} > 0 \qquad ( Condition 3 )$$

$$Herein , PL\_ 1 = P\_od - ( P\_t - Pref\_d ) / TAN θ$$

As described above, Expression (1) and Expression (2) are exemplary expressions when P_margin is generalized to the configuration with five or more reflections. Specifically, Expression (1) and Expression (2) include an expression obtained by expanding five reflections to the odd number of reflections exceeding five reflections based on the configuration of the imaging lens 1 illustrated in FIG. 1 and an expression obtained by expanding the five reflections to the even-reflection configuration performing the even number of reflections not less than six reflections.

Condition 3 is established even in the number of reflections more than five reflections. For example, in the case of six reflections, because the second slope 306 becomes parallel to the first slope 303, a position where the lower ray a3 becomes the fourth reflection inside the reflective light guide element 30 is b1, and a margin is provided between the position b1 and the surface on which the sixth reflection is performed, that is, between the position on the surface of the first plane 304 and the boundary b2 between the surface of the first plane 304 and the surface and the second slope 306. Moreover, in the case of seven reflections, a margin is provided, inside the reflective light guide element 30, between the position b1 where the lower ray a3 becomes the fifth reflection and the surface on which the seventh reflection is performed, that is, between the position on the surface of the second plane 305 and the boundary b2 between the surface of the second plane 305 and the surface of the second slope 306.

In other words, in the case of n reflections (n is an integer of 5 or more), a margin is provided, inside the reflective light guide element 30, between the position where the lower ray a3 becomes the (n−2)th reflection and the surface on which the n-th reflection is performed. By Condition 3, when the reflective light guide element in which five or more reflections are performed is included in the imaging lens, the lenses and the reflective light guide element are enough to have a configuration that satisfies the condition of “margin>0”.

Note that, because Expression (1) and Expression (2) are expressions based on the exemplary configuration of the imaging lens 1 illustrated in FIG. 1, the imaging lens that can be implemented with five or more reflections is not necessarily limited to the configuration that satisfies the relationship of Expression (1) or Expression (2).

### EXAMPLES

Conditions 1 to 8 may be implemented in combination as appropriate. Next, some configurations for the imaging lens 1 are illustrated, and simulation results of implementation data satisfying the conditions are illustrated.

First, Example 1 illustrates an Example in the exemplary configuration illustrated in the imaging lens 1 of FIG. 1, and then Example 2 and Example 3 are illustrated as Examples when lens settings are different. Note that, unless otherwise described, the optical path with five reflections in the imaging lens is illustrated in the same display format as the left diagram of FIG. 1. Moreover, below Example 2, common elements such as the diaphragm 10, the lens group 20, the reflective light guide element 30, and the IR filter 40 of the imaging lens 1 illustrated in FIG. 1 are respectively indicated with the same names, like a diaphragm, a lens group, a reflective light guide element, an IR filter, etc., and have the changed reference numbers every Example.

### Example 1

Example 1 is an example when using the lens group 20 with four-piece configuration of the 35 mm-converted focal length of 132 mm by the ½ inch sensor and FNO of 3.5 in the exemplary configuration illustrated in the imaging lens 1 of FIG. 1. The following Tables 1 to 4 are tables obtained by summarizing the optical settings of the exemplary configuration illustrated in the imaging lens 1 of FIG. 1.

TABLE 1

| | SURFACE | | | | | | | | |
|---|---|---|---|---|---|---|---|---|---|
| | NUMBER | R | D | Nd | Vd | FOCAL LENGTH | | | |
| | 0 | INF | INF | | | | | | |
| | 1 | INF | 0.400 | | | | | | |
| DIAPHRAGM | STO | INF | −0.400 | | | | | | |
| L1 | 3 | 11.896 | 1.147 | 1.552 | 70.70 | 21.350 | 6.705 | 25.009 | f_F |
| | 4 | −1046.782 | 0.106 | | | | | | |
| L2 | 5 | 6.392 | 1.301 | 1.544 | 56.33 | 9.304 | | | |
| | 6 | −22.458 | 0.362 | | | | | | |
| L3 | 7 | −251.603 | 0.500 | 1.588 | 28.27 | −12.738 | −6.346 | | f_B2 |
| | 8 | 7.696 | 0.616 | | | | | | |
| L4 | 9 | −26.017 | 0.500 | 1.544 | 56.33 | −13.499 | | | |
| | 10 | 10.285 | 0.821 | | | | | | |
| REFLECTIVE | 11 | INF | 23.000 | 1.517 | 64.17 | | | | |
| LIGHT GUIDE | 12 | INF | 0.345 | | | | | | |
| ELEMENT | | | | | | | | | |
| IR FILTER | 13 | INF | 0.210 | 1.517 | 64.17 | | | | |
| | 14 | INF | 0.350 | | | | | | |
| | 15 | INF | 0.000 | | | | | | |

Table 1 illustrates R (CURVATURE RADIUS), D (INTERVAL), Nd (REFRACTIVE INDEX), Vd (ABBE NUMBER), and Focal length.

Moreover, Table 1 illustrates positions corresponding to the diaphragm 10, the lenses of the lens group 20, the reflective light guide element 30, and the IR filter 40 outside the table. For example, data of “STO” illustrated in “Surface number” is data of the diaphragm 10. The data of “3” and “4” illustrated in “Surface number” are data of the first lens L1. “3” is data of the object-side surface, and “4” is data of the image-side surface. Similarly, data of “5” and “6” illustrated in “Surface number” are data of the second lens L2. “5” is data of the object-side surface, and “6” is data of the image-side surface. The data of “7” and “8” illustrated in “Surface number” are data of the third lens L3. “7” is data of the object-side surface, and “8” is data of the image-side surface. The data of “9” and “10” illustrated in “Surface number” are data of the fourth lens L4. “9” is data of the object-side surface, and “10” is data of the image-side surface.

The data of “11” illustrated in “Surface number” is data of the reflective light guide element 30. The data of “13” illustrated in “Surface number” is data of the IR filter 40.

Moreover, in Table 1, “f_B2” indicates a focal length (composite focal length) of rear two lenses. The “rear two lenses” mean, among the lenses of the lens configuration, two lenses of a lens through which the light from the object side passes finally and a lens just before the final one. “f_F” indicates a focal length (composite focal length) of front lenses other than the rear two lenses. The “front lenses other than the rear two lenses” mean, among the lenses of the lens configuration, the remaining lenses other than the rear two lenses.

Because the configuration illustrated in FIG. 1 has the lens group 20 with a four-piece configuration, “f_F” is a focal length of the first lens L1 and the second lens L2 that are the front two lenses. In the case of a five-piece configuration, “f_F” is a focal length of the front three lenses among the first lens L1 to the fifth lens L5. In the case of a six-piece configuration, “f_F” is a focal length of the front four lenses among the first lens L1 to the sixth lens L6.

Note that the viewpoint of these data is similar even in other Examples.

TABLE 2

| | SURFACE NUMBER | | | | | | | |
|---|---|---|---|---|---|---|---|---|
| | 3 | 4 | 5 | 6 | 7 | 8 | 9 | 10 |
| K | 0 | 0 | 1.589626 | 41.926406 | −99.000000 | 1.545900 | 1.207531 | 14.116703 |
| A4 | 0 | 0 | 1.793513.E−04 | 1.298301.E−02 | 1.716821.E−02 | 4.291268.E−03 | 8.505984.E−03 | 9.520241.E−03 |
| A6 | 0 | 0 | −5.368267.E−04 | −7.833845.E−03 | −1.599449.E−02 | −9.155333.E−03 | −2.705590.E−04 | −2.625439.E−04 |
| A8 | 0 | 0 | 1.402739.E−04 | 2.979074.E−03 | 7.602528.E−03 | 4.836958.E−03 | −3.873068.E−04 | −3.606376.E−04 |
| A10 | 0 | 0 | −3.566785.E−05 | −7.064929.E−04 | −2.033655.E−03 | −1.000756.E−03 | 4.824200.E−04 | 1.730797.E−04 |
| A12 | 0 | 0 | 6.495485.E−06 | 1.120500.E−04 | 3.445436.E−04 | 5.306118.E−05 | −2.206675.E−04 | −7.772276.E−05 |
| A14 | 0 | 0 | −7.708115.E−07 | −1.209412.E−05 | −3.859552.E−05 | 1.618866.E−05 | 5.354918.E−05 | 2.345091.E−05 |
| A16 | 0 | 0 | 5.370507.E−08 | 8.540642.E−07 | 2.807801.E−06 | −3.643799.E−06 | −7.487330.E−06 | −4.252464.E−06 |
| A18 | 0 | 0 | −2.019126E−09 | −3.541168E−08 | −1.203829E−07 | 3.119965E−07 | 5.728766E−07 | 4.196989E−07 |
| A20 | 0 | 0 | 3.247620E−11 | 6.516538E−10 | 2.300249E−09 | −1.014335E−08 | −1.850725E−08 | −1.752044E−08 |

Table 2 illustrates the shape data of an aspheric surface of the lenses (Surface number 3 to Surface number 10) in the lens group 20.

TABLE 3

| | INF | |
|---|---|---|
| LTL | 29.258 | mm |
| da | 7.040 | mm |
| L | 5.353 | mm |
| EPD | 5.417 | mm |
| AREA1 | 2.213 | mm |
| PL_1 | 13.699 | mm |
| PL_2 | 12.395 | mm |
| PL_2′ | 13.321 | mm |
| P_margin | 0.378 | mm |
| DFOV | 18.435 | deg |
| dd | 4.096 | mm |
| EFL | 25.009 | mm |
| FNO | 3.552 | |
| f_B2 | −6.346 | mm |
| f_F | 6.705 | mm |
| f_B2/f_F | −0.947 | |
| EFL/dd | 6.106 | |
| EPD/PL | 0.236 | |
| EPD/Pref_d | 2.995 | |

Table 3 illustrates data of the entire main parameters in the exemplary configuration illustrated in the imaging lens 1 of FIG. 1. Herein, “LTL” is a parameter indicating the total length of the lens. The total length of the lens is a total optical path length from the lens vertex of the first surface of the first lens L1 to the sensor surface. “da” is a parameter indicating the diameter of the diaphragm 10. “DFOV” is a parameter indicating the diagonal FOV of the lens. “FNO” is F-number. “EFL” is a focal length of the entire lens. “EFL” corresponds to a focal length from the first lens L1 to the fourth lens L4 in the focal length illustrated in Table 1. Because the other parameters have been already explained, their descriptions are omitted.

TABLE 4
REFLECTIVE LIGHT GUIDE ELEMENT

| | INF | |
|---|---|---|
| Pref_d | 1.809 | mm |
| P_t | 3.327 | mm |
| θ | 29.0 | deg |
| P_od | 16.437 | mm |
| PL: PRISM OPTICAL LENGTH | 23.000 | mm |

Table 4 illustrates data associated with the configuration of the reflective light guide element 30. Note that their descriptions are omitted because symbols of parameters illustrated in Table 4 have been already explained.

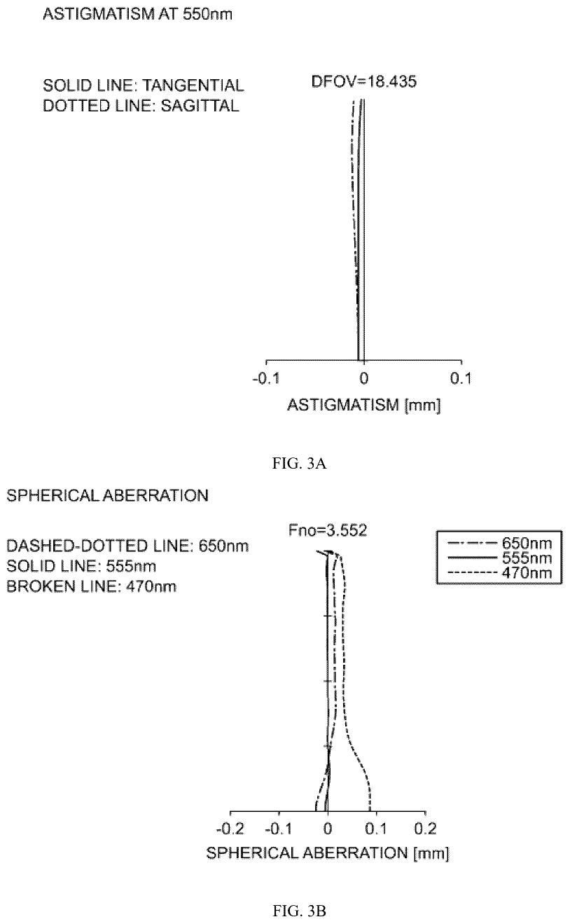

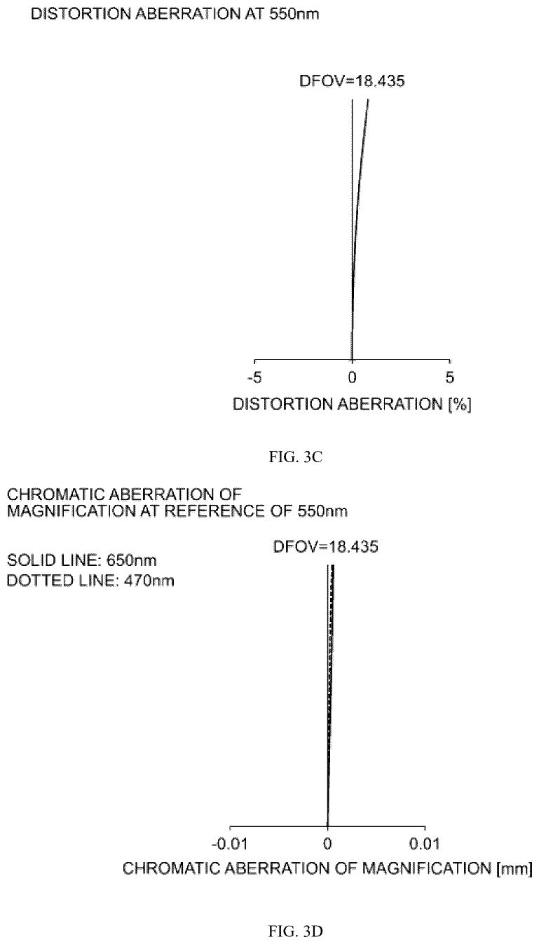

FIGS. 3A, 3B, 3C, and 3D are aberration diagrams of the imaging lens 1 according to Example 1.

FIG. 3A illustrates an aberration diagram of an astigmatism with reference to an imaging surface, and the horizontal axis illustrates an image height and the vertical axis illustrates the size of an aberration. FIG. 3A illustrates a case where 18.435° of DFOV that is the diagonal angle of view of an imaging lens 2 is the maximum image height. In the aberration diagram of the imaging lens 2 illustrated in FIG. 3A, an aberration amount on a tangential surface at Wavelength: 550 nm is illustrated with a solid line, and an aberration amount on a sagittal surface is illustrated with a dotted line. The tangential surface is a surface including a principal ray passing through the imaging lens 2 and the optical axis of the imaging lens 2. The sagittal surface is a surface including a principal ray passing through the imaging lens 2 and perpendicular to the tangential surface.

FIG. 3B illustrates an aberration diagram of a spherical aberration with reference to the imaging surface, the horizontal axis illustrates an eye image height and the vertical axis illustrates the size of an aberration. FIG. 3B illustrates a case of “F-number Fno=3.552”. In the aberration diagram of the optical system of a lens group 21 illustrated in FIG. 3B, an aberration amount for Wavelength: 650 nm is illustrated with a dashed-dotted line, an aberration amount for Wavelength: 555 nm is illustrated with a solid line, and an aberration amount for Wavelength: 470 nm is illustrated with a dotted line.

FIG. 3C illustrates an aberration diagram of a distortion aberration with reference to the imaging surface, and the horizontal axis illustrates an image height and the vertical axis illustrates the size of an aberration. FIG. 3C illustrates a case where 18.435° of DFOV that is the diagonal angle of view of the imaging lens 2 is the maximum image height. In the aberration diagram of the imaging lens 2 illustrated in FIG. 3C, an aberration amount for Wavelength: 550 nm is illustrated with a solid line.

FIG. 3D illustrates an aberration diagram of a chromatic aberration of magnification with reference to the imaging surface, and the horizontal axis illustrates an image height and the vertical axis illustrates the size of an aberration. FIG. 3D illustrates a case where 18.435° of DFOV that is the diagonal angle of view of the imaging lens 2 is the maximum image height. In the aberration diagram of the imaging lens 2 illustrated in FIG. 3D, an aberration amount on the sagittal surface for Wavelength: 550 nm is illustrated with a solid line, and an aberration amount on the tangential surface is illustrated with a dotted line.

It turns out that each aberration is adjusted appropriately from FIGS. 3A, 3B, 3C, and 3D. Moreover, in the exemplary configuration illustrated in the imaging lens 1 of FIG. 1, “P_margin” illustrated in Table 3 is 0.378 mm by taking the setting of Tables 1 to 4. As described above, because “P_margin=PL_1-PL_2′>0” of the conditional expression is also satisfied and “P_margin >0” is satisfied from the optical path of FIG. 1, manufacturing is possible and the five-reflection configuration is implementable.

### Example 2

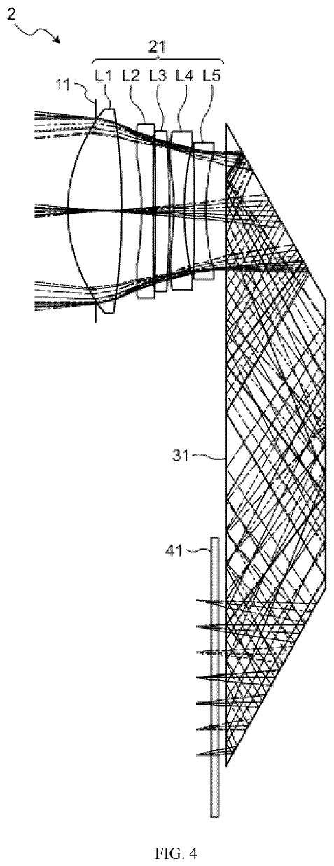

Example 2 is an example when using the lens group 21 with five-piece configuration of the 35 mm-converted focal length of 136 mm by the ½ inch sensor and FNO of 4.0 in the exemplary configuration illustrated in the imaging lens 2 illustrated in FIG. 4. FIG. 4 is a diagram explaining a configuration of the imaging lens 2 according to Example 2. As illustrated in FIG. 4, the imaging lens 2 includes the lens group 21 with five-piece configuration. The imaging lens 2 illustrated in FIG. 4 includes a diaphragm 11, the lens group 21, and a reflective light guide element 31. The light from the object side passes through the diaphragm 11, the lens group 21, and the reflective light guide element 31 in this order, and is emitted toward an IR filter 41.

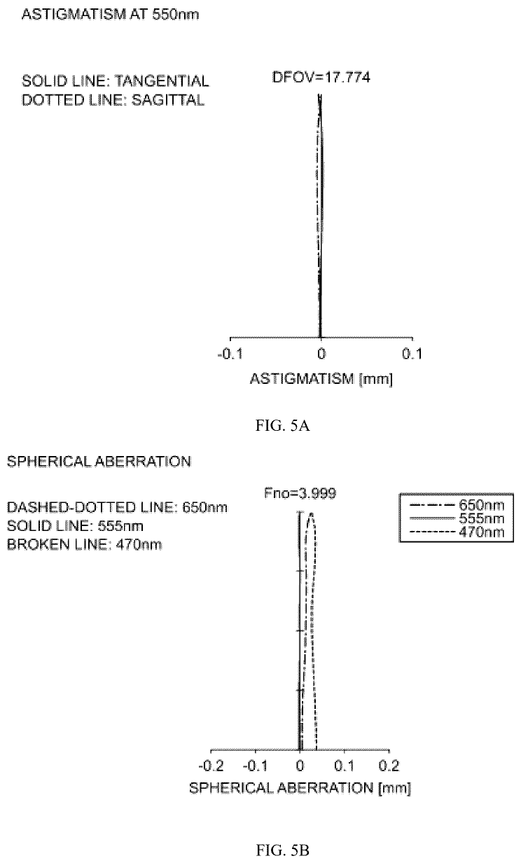

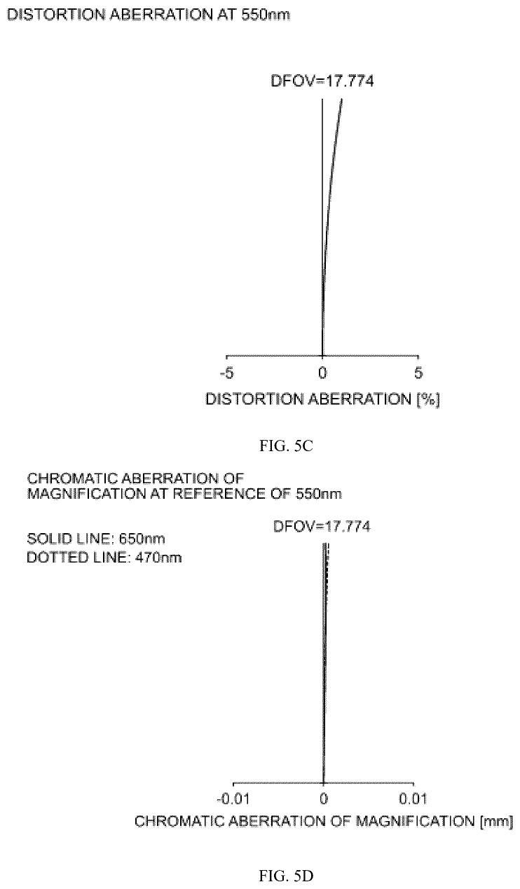

Table 5 to Table 8 are tables obtained by summarizing the optical settings of the configuration of the imaging lens 2 illustrated in FIG. 4. FIGS. 5A, 5B, 5C, and 5D are aberration diagrams of the imaging lens 2 according to Example 2.

TABLE 5

| | SURFACE | | | | | | | | |
|---|---|---|---|---|---|---|---|---|---|
| | NUMBER | R | D | Nd | Vd | FOCAL LENGTH | | | |
| | 0 | INF | INF | | | | | | |
| | 1 | INF | 1.000 | | | | | | |
| DIAPHRAGM | STO | INF | −1.000 | | | | | | |
| L1 | 3 | 5.296 | 1.906 | 1.544 | 56.33 | 7.597 | 7.030 | 25.753 | f_F |
| | 4 | −16.353 | 0.653 | | | | | | |
| L2 | 5 | −10.723 | 0.400 | 1.544 | 56.33 | −12.279 | | | |
| | 6 | 29.207 | 0.050 | | | | | | |
| L3 | 7 | 11.703 | 0.556 | 1.588 | 28.27 | 10.166 | | | |
| | 8 | −14.196 | 0.098 | | | | | | |
| L4 | 9 | −11.028 | 0.400 | 1.544 | 56.33 | −10.879 | −6.365 | | f_B2 |
| | 10 | 17.104 | 0.328 | | | | | | |
| L5 | 11 | −150.5619 | 0.400 | 1.517 | 64.17 | −16.35870585 | | | |
| | 12 | 9.4567 | 0.695 | | | | | | |
| REFLECTIVE | 13 | INF | 22.573 | 1.517 | 64.17 | | | | |
| LIGHT GUIDE | 14 | INF | 0.300 | | | | | | |
| ELEMENT | | | | | | | | | |
| IR FILTER | 15 | INF | 0.210 | 1.517 | 64.17 | | | | |
| | 16 | INF | 0.497 | | | | | | |
| | 17 | INF | 0.000 | | | | | | |

TABLE 6

| | SURFACE NUMBER | | | | | |
|---|---|---|---|---|---|---|
| | 3 | 4 | 5 | 6 | 7 | 8 |
| K | 0.463432 | 9.151039 | −27.836402 | 99.000000 | 5.830409 | −98.819038 |
| A4 | −2.307033.E−04 | 9.903094.E−04 | 3.266175.E−04 | −5.609133.E−03 | −9.311032.E−03 | −3.446840.E−03 |
| A6 | −2.554812.E−05 | 4.202681.E−05 | 1.287086.E−04 | 3.881615.E−04 | 3.569083.E−04 | 2.063189.E−04 |
| A8 | 3.212384.E−07 | −1.002659.E−06 | 1.764419.E−05 | −1.640855.E−06 | 2.737741.E−05 | 1.106962.E−04 |
| A10 | −1.780141.E−07 | −1.044063.E−07 | −3.232824.E−07 | −6.685546.E−08 | −8.768017.E−06 | −1.053780.E−05 |
| A12 | −8.984879.E−09 | −1.316024.E−09 | −3.623899.E−08 | 4.342567.E−07 | 1.161146.E−06 | −3.804933.E−07 |
| A14 | 1.616281.E−09 | −7.367785.E−10 | 2.949640.E−09 | −1.252317.E−08 | −2.393912.E−08 | 1.656615.E−07 |
| A16 | −1.423981.E−10 | 3.627161.E−11 | −4.400566.E−10 | −4.971434.E−09 | −1.191043.E−09 | −5.281010.E−09 |
| A18 | 0.000000.E+00 | 0.000000.E+00 | 0.000000E+00 | 0.000000E+00 | 0.000000E+00 | 0.000000E+00 |
| A20 | 0.000000.E+00 | 0.000000.E+00 | 0.000000E+00 | 0.000000E+00 | 0.000000E+00 | 0.000000E+00 |

| | SURFACE NUMBER | | | |
|---|---|---|---|---|
| | 9 | 10 | 11 | 12 |
| K | −60.400212 | 37.637535 | −99.000000 | 8.734514 |
| A4 | −4.457587.E−04 | 2.429971.E−04 | −6.474173.E−04 | 2.165831.E−03 |
| A6 | 3.140538.E−04 | 5.600298.E−04 | 9.390896.E−04 | −2.039912.E−04 |
| A8 | 4.779050.E−06 | −3.981133.E−05 | −1.941030.E−04 | −1.082655.E−04 |
| A10 | 4.996614.E−06 | −2.112001.E−05 | 1.516981.E−07 | 9.330736.E−06 |
| A12 | 6.227445.E−08 | 1.650422.E−06 | −6.644458.E−07 | 5.802131.E−07 |
| A14 | 1.263266.E−08 | 5.946819.E−07 | 6.877512.E−07 | −3.576992.E−08 |
| A16 | −9.388831.E−09 | −6.752787.E−08 | −5.144124.E−08 | −6.083758.E−09 |
| A18 | 0.000000E+00 | 0.000000E+00 | 0.000000.E+00 | 0.000000.E+00 |
| A20 | 0.000000E+00 | 0.000000E+00 | 0.000000.E+00 | 0.000000.E+00 |

TABLE 7

| | INF | |
|---|---|---|
| LTL | 29.067 | mm |
| da | 6.440 | mm |
| L | 5.487 | mm |
| EPD | 4.651 | mm |
| AREA1 | 1.886 | mm |
| PL_1 | 13.228 | mm |
| PL_2 | 11.690 | mm |
| PL_2′ | 12.572 | mm |
| P_margin | 0.657 | mm |
| DFOV | 17.773 | deg |
| dd | 4.096 | mm |
| EFL | 25.753 | mm |
| FNO | 3.999 | |
| f_B2 | −6.365 | mm |
| f_F | 7.030 | mm |
| f_B2/f_F | −0.905 | |
| EFL/dd | 6.287 | |
| EPD/PL | 0.206 | |
| EPD/Pref_d | 2.736 | |

TABLE 8
REFLECTIVE LIGHT GUIDE ELEMENT

| | INF | |
|---|---|---|
| Pref_d | 1.700 | mm |
| P_t | 3.380 | mm |
| θ | 29.0 | deg |
| P_od | 16.259 | mm |
| PRISM LENGTH PL | 22.573 | mm |

It turns out that each aberration is adjusted appropriately from FIGS. 5A, 5B, 5C, and 5D. Moreover, “P_margin” illustrated in Table 7 is 0.657 mm by taking the settings of Table 5 to Table 8 for the imaging lens 2. As described above, because “P_margin=PL_1-PL_2′>0” of the conditional expression is also satisfied and “P_margin >0” is satisfied from the optical path illustrated in FIG. 4, manufacturing is possible and the five-reflection configuration is implementable even when the five-piece configuration is used.

### Example 3

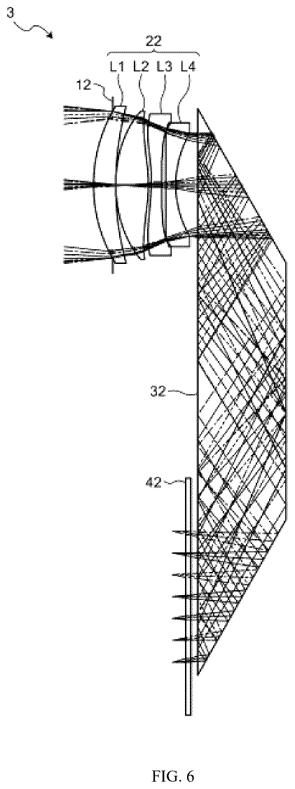

Example 3 is an example when using a lens group 22 with four-piece configuration of the 35 mm-converted focal length of 129 mm by the ½ inch sensor and FNO of 4.0 in the exemplary configuration illustrated in an imaging lens 3 of FIG. 6. FIG. 6 is a diagram explaining a configuration of the imaging lens 3 according to Example 3. As illustrated in FIG. 6, the imaging lens 3 includes the lens group 22 with four-piece configuration. The imaging lens 3 illustrated in FIG. 6 includes a diaphragm 12, the lens group 22, and a reflective light guide element 32. The light from the object side passes through the diaphragm 12, the lens group 22, and the reflective light guide element 32 in this order, and is emitted toward an IR filter 42.

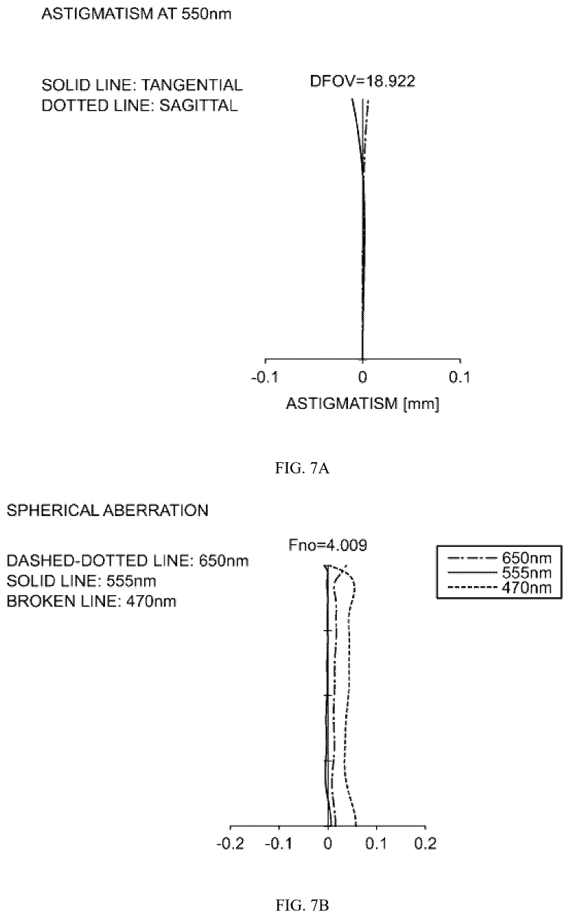

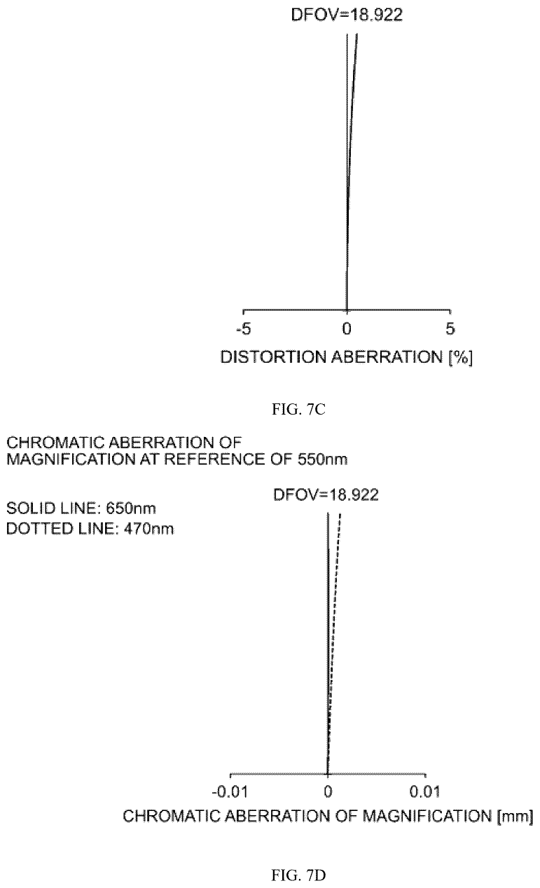

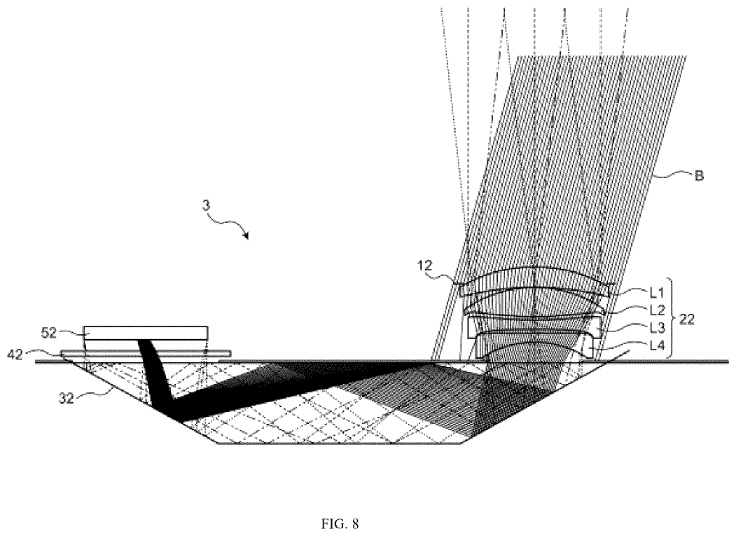

Table 9 to Table 12 are tables obtained by summarizing the optical settings of the configuration of the imaging lens 3 illustrated in FIG. 6. FIGS. 7A, 7B, 7C, and 7D are aberration diagrams of the imaging lens 3 according to Example 3.

TABLE 9

| | SURFACE | | | | | | | | |
|---|---|---|---|---|---|---|---|---|---|
| | NUMBER | R | D | Nd | Vd | FOCAL LENGTH | | | |
| | 0 | INF | INF | | | | | | |
| | 1 | INF | 0.800 | | | | | | |
| DIAPHRAGM | STO | INF | −0.800 | | | | | | |
| L1 | 3 | 11.896 | 0.873 | 1.705 | 41.14 | 20.147 | 5.305 | 24.257 | f_F |
| | 4 | −1046.782 | 0.050 | | | | | | |
| L2 | 5 | 6.392 | 1.278 | 1.544 | 56.33 | 6.621 | | | |
| | 6 | −22.458 | 0.119 | | | | | | |
| L3 | 7 | −251.603 | 0.416 | 1.588 | 28.27 | −25.843 | −4.907 | | f_B2 |
| | 8 | 7.696 | 0.167 | | | | | | |
| L4 | 9 | −26.017 | 0.400 | 1.567 | 37.56 | −6.171 | | | |
| | 10 | 10.285 | 0.897 | | | | | | |
| REFLECTIVE | 11 | INF | 23.500 | 1.517 | 64.17 | | | | |
| LIGHT GUIDE | 12 | INF | 0.300 | | | | | | |
| ELEMENT | | | | | | | | | |
| IR FILTER | 13 | INF | 0.210 | 1.517 | 64.17 | | | | |
| | 14 | INF | 0.490 | | | | | | |
| | 15 | INF | 0.000 | | | | | | |

TABLE 10

| | SURFACE NUMBER | | | | | | | |
|---|---|---|---|---|---|---|---|---|
| | 3 | 4 | 5 | 6 | 7 | 8 | 9 | 10 |
| K | 0 | 0 | −23.154560 | −32.775668 | 60.585169 | 62.437265 | −57.111072 | 3.484979 |
| A4 | 0 | 0 | 1.105636.E−02 | 8.107849.E−03 | 9.709437.E−05 | −1.133146.E−03 | 4.782779.E−02 | 3.733761.E−02 |
| A6 | 0 | 0 | −2.085167.E−03 | −2.831934.E−03 | 1.837061.E−03 | 1.773206.E−02 | −1.274865.E−02 | −2.302187.E−02 |
| A8 | 0 | 0 | 6.891310.E−04 | 5.694805.E−04 | −3.811549.E−03 | −1.831255.E−02 | −2.273817.E−03 | 9.293432.E−03 |
| A10 | 0 | 0 | −2.117870.E−04 | −1.868306.E−04 | 2.061605.E−03 | 8.641764.E−03 | 1.941890.E−03 | −3.132661.E−03 |
| A12 | 0 | 0 | 5.044861.E−05 | 8.865052.E−05 | −5.354420.E−04 | −2.328871.E−03 | −4.064534.E−04 | 8.078013.E−04 |
| A14 | 0 | 0 | −8.484776.E−06 | −2.356101.E−05 | 7.787874.E−05 | 3.839766.E−04 | 2.011845.E−05 | −1.440241.E−04 |
| A16 | 0 | 0 | 9.558471.E−07 | 3.257295.E−06 | −6.474608.E−06 | −3.831439.E−05 | 5.282340.E−06 | 1.601567.E−05 |
| A18 | 0 | 0 | −6.506953E−08 | −2.275678E−07 | 2.893972E−07 | 2.109432E−06 | −8.925198E−07 | −9.639359E−07 |
| A20 | 0 | 0 | 1.993748E−09 | 6.440654E−09 | −5.488988E−09 | −4.679364E−08 | 4.309155E−08 | 2.199342E−08 |

TABLE 11

| | INF | |
|---|---|---|
| LTL | 28.700 | mm |
| da | 6.050 | mm |
| L | 28.000 | mm |
| EPD | 4.627 | mm |
| AREA1 | 0.056 | mm |
| PL_1 | 13.750 | mm |
| PL_2 | 8.576 | mm |
| PL_2′ | 9.280 | mm |
| P_margin | 4.470 | mm |
| DFOV | 18.922 | deg |
| dd | 4.059 | mm |
| EFL | 24.257 | mm |
| FNO | 4.009 | |
| f_B2 | 0.000 | mm |
| f_F | 5.305 | mm |
| f_B2/f_F | 0.000 | |
| EFL/dd | 5.976 | |
| EPD/PL | 0.197 | |
| EPD/Pref_d | 2.625 | |

TABLE 12
REFLECTIVE LIGHT GUIDE ELEMENT

| | INF | |
|---|---|---|
| Pref_d | 1.763 | mm |
| P_t | 3.530 | mm |
| θ | 29.0 | deg |
| P_od | 16.938 | mm |
| PRISM LENGTH PL | 23.500 | mm |

It turns out that each aberration is adjusted appropriately from FIGS. 7A, 7B, 7C, and 7D. Moreover, “P_margin” illustrated in Table 11 is 4.470 mm by taking the settings of Table 9 to Table 12 for the imaging lens 3. As described above, because “P_margin=PL_1-PL_2′>0” of the conditional expression is also satisfied and “P_margin >0” is satisfied from the optical path of FIG. 6, manufacturing is possible even in the present configuration and the five-reflection configuration is implementable.

### Method of Reducing or Cutting Unnecessary Rays in Reflective Light Guide Element

Next, by using the configuration of the imaging lens 3 illustrated in FIG. 6 as an example, a method of reducing or cutting unnecessary rays when the five-reflection configuration is applied will be described. First, a method of cutting ghost light as unnecessary rays will be described.

FIG. 8 is a diagram illustrating an example of optical paths of effective rays and optical paths of ghost light in the imaging lens 3 illustrated in FIG. 6. The optical paths of the effective rays indicate optical paths of rays necessary for the generation of an image of the object. FIG. 8 illustrates the optical paths of ghost light B overlapped on the optical paths of the ray bundle of the principal ray, the lower ray, and the upper ray. FIG. 8 illustrates the optical paths of the ghost light B with a solid diagonal line.

In the reflective light guide element 32 with five reflections illustrated in FIG. 8, until the rays incident from the lens group 12 are emitted toward the IR filter 42, the ghost light B passes through a range similar to a range occupied by the optical paths of the effective rays at angles different from those of the effective rays. For this reason, it is difficult to distinguish between a space through which only the effective rays pass and a space through which only the ghost light B passes. Thus, it is impossible to apply the method of cutting the ghost light B by dividing the reflective light guide element into portions through which only the ghost light B passes, which is applicable when the number of reflections is small, and applying light shielding ink or providing a groove in a portion of the reflective light guide element.

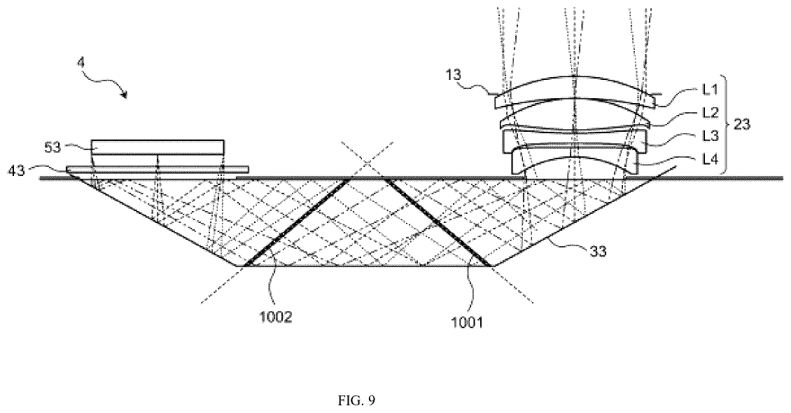

FIG. 9 is a diagram illustrating an example of the method of cutting the ghost light B. An imaging lens 4 illustrated in FIG. 9 is an example when an air layer of cutting the ghost light B is provided in the imaging lens 3 illustrated in FIG. 8. Because the configuration illustrated in FIG. 9 has two air layers, the reflective light guide element 32 is divided into three to provide the two air layers in the explanation to be described later, but the division is not limited to three.

Herein, the division is division for providing an air layer medium with a minute width in the same one reflective light guide element 30, but is not division for separating different reflective light guide elements.

As illustrated in FIG. 9, in a reflective light guide element 33 of the imaging lens 4, on the optical paths inside the reflective light guide element 33 of the light incident from a lens group 23, a first air layer 1001 and a second air layer 1002 are diagonally provided with reference to the lens optical axis of the lens group 23. The configuration of a diaphragm 13, the lens group 23, an IR filter 43, and an imaging element 53 illustrated in FIG. 9 corresponds to the configuration of the diaphragm 12, the lens group 22, the IR filter 42, and an imaging element 52 illustrated in FIG. 8.

The reflective light guide element 33 illustrated in FIG. 9 includes the first air layer 1001 provided at the first division point and the second air layer 1002 provided at the second division point, by dividing the reflective light guide element 32 with five reflections illustrated in FIG. 8 into three.

In the reflective light guide element 33 illustrated in FIG. 9, as illustrated by dotted lines in FIG. 9, both of a line obtained by extending the first air layer 1001 in the first air layer 1001 and a line obtained by extending the second air layer 1002 in the second air layer 1002 are diagonally divided to intersect with each other on the first plane side on which the incident surface of the reflective light guide element 33 is located.

The reflective light guide element 33 illustrated in FIG. 9 is an optical system that is divided into three at an angle of 90°±30° with reference to rays inside the reflective light guide element 33 that pass on the lens optical axis of the lens group 23 and pass inside the reflective light guide element 33. In other words, the first air layer 1001 and the second air layer 1002 are provided at the respective positions at the angle of 90°±30° with reference to the rays inside the reflective light guide element 33 that pass on the lens optical axis of the lens group 23 and pass inside the reflective light guide element 33.

Note that the first air layer 1001 and the second air layer 1002 are provided by the division in the example illustrated in FIG. 9, but the first air layer 1001 and the second air layer 1002 may be provided by grooves etc. in portions of the reflective light guide element 33 in the division direction.

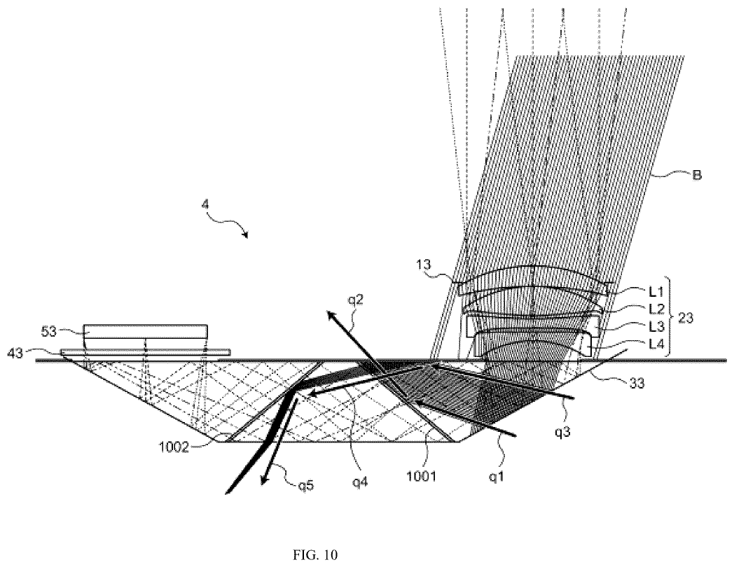

FIG. 10 is a diagram explaining a principle that the ghost light B is cut from the effective rays in the imaging lens 4 illustrated in FIG. 9. FIG. 10 illustrates the optical paths of the ray bundle of the principal ray, the lower ray, and the upper ray and the optical paths of the ghost light B overlapped on the imaging lens 4 illustrated in FIG. 9. In FIG. 9, the optical paths of the ghost light B are illustrated with a solid diagonal line.

In the configuration of the imaging lens 4 illustrated in FIG. 10, inside the reflective light guide element 33, the effective rays have a small incident angle when being incident on a boundary surface with the first air layer 1001 that has a different medium. Moreover, the effective rays have a small incident angle also when being incident on a boundary surface with the second air layer 1002 that has a different medium. Therefore, the effective rays can pass through the first air layer 1001 and the second air layer 1002 and reach the sensor surface like the ray optical paths illustrated in FIG. 8.

On the contrary, among rays of the ghost light B, there are rays with an angle at which an incident angle when being incident on the boundary surface with the first air layer 1001 having a different medium is the total reflection. An arrow q1 and an arrow q2 illustrated in FIG. 10 are respectively an arrow indicating the incident direction and an arrow indicating the reflection direction of the ghost light B that is incident at an angle at which the total reflection occurs in the first air layer 1001. As described above, among the rays of the ghost light B, rays incident on the first air layer 1001 at the angle at which the total reflection occurs are reflected and cut in a direction different from the sensor surface side.

Moreover, some or all of the other rays of the ghost light B are cut by the total reflection when they are incident on the boundary surface with the second air layer 1002 having a different medium. An arrow q3 and an arrow q4 illustrated in FIG. 10 respectively are an arrow indicating the incident direction and an arrow indicating the reflection direction of rays of the ghost light B totally reflected on the first plane. The rays of the ghost light B totally reflected on the first plane heads for the second air layer 1002. The arrow q4 and an arrow q5 illustrated in FIG. 10 respectively are an arrow indicating the incident direction and an arrow indicating the reflection direction of light incident at the angle at which the total reflection occurs when the ghost light is incident on the boundary surface with the second air layer 1002 having a different medium. As described above, the other rays of the ghost light B are cut by the reflection because the second air layer 1002 exists.

Therefore, because the ghost light B is cut by the first air layer 1001 and the second air layer 1002, the ghost light cannot reach the sensor surface.

Note that a medium is air because the insides of the first air layer 1001 and the second air layer 1002 are satisfied with air. Herein, it has been explained that the first medium and the second medium are air, but the first medium and the second medium are not limited to air.

When the refractive indices of the first medium and the second medium are smaller than the refractive index of the reflective light guide element 33 and when the first medium and the second medium are diagonally arranged with respect to the direction of the lens optical axis, it is sufficient if the media are a medium having a refractive index by which a portion of the aimed light included in the passing light causes the total reflection. Because the ghost light B is included in the passing light, the first medium and the second medium are diagonally arranged with respect to the direction of the lens optical axis, aiming for the ghost light B incident at an incident angle different from the incident angle of the effective light in the passing area.

Moreover, a medium having a refractive index such that the ghost light B causes the total reflection at the desired incident angle is applied to the first medium and the second medium. The refractive index such that the ghost light B causes the total reflection at the desired incident angle is a refractive indices having a refractive index difference at which the total reflection is achieved at the desired incident angle by a refractive index difference with the refractive index of the medium of the reflective light guide element 33.

For materials, in the configuration illustrated in FIG. 10, for example, the inside of the first air layer 1001 may be satisfied with a glass material having a refractive index by which the total reflection of the light occurs in the directions indicated by the arrow q1 and the arrow q2. Moreover, the inside of the second air layer 1002 may be satisfied with a glass material having a refractive index by which the total reflection of the light occurs in the directions indicated by the arrow q4 and the arrow q5. Moreover, the inside of the first air layer 1001 and the inside of the second air layer 1002 may be satisfied with a medium other than the glass material.

Moreover, similar to the above even if the reflective light guide element has a configuration with the number of reflections larger than five, there may be provided a medium of causing the effective rays such as an image to pass and cutting the ghost light B inside the reflective light guide element at the angle at which the ghost light B is totally reflected.

### Example 4

Example 4 is an example of simulation data when using the lens group 23 with four-piece configuration of the 35 mm-converted focal length of 131 mm by the ½ inch sensor and FNO of 4.0 in the exemplary configuration illustrated in the imaging lens 4 illustrated in FIG. 9.

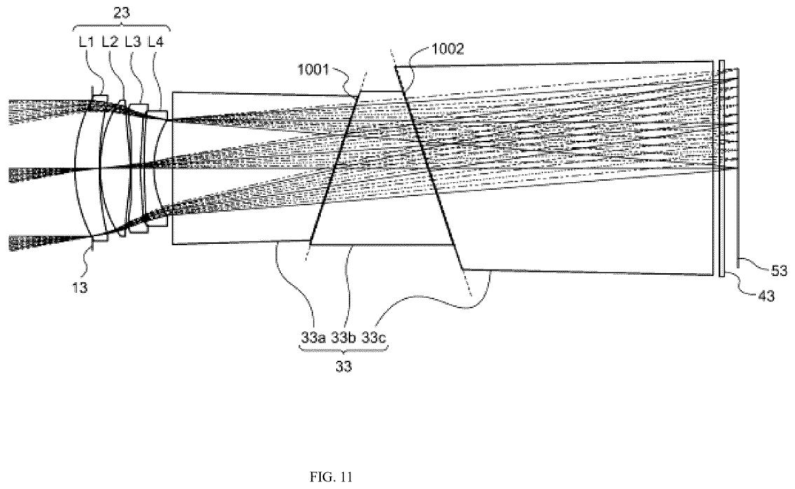

The following Table 13 to Table 16 are tables obtained by summarizing the optical settings of the exemplary configuration illustrated in the imaging lens 4 of FIG. 9. FIG. 11 is a diagram illustrating the imaging lens 4 illustrated in FIG. 9 in a different display format. FIG. 11 illustrates, in the display format in which the ray optical paths are linearly illustrated without reflecting the ray optical paths, prisms 33a, 33b, and 33c of the optical system divided into three parts and the first and second air layers 1001 and 1002 in the reflective light guide element 33 of the imaging lens 4 with the arrangement corresponding to the imaging lens 4 illustrated in FIG. 9.

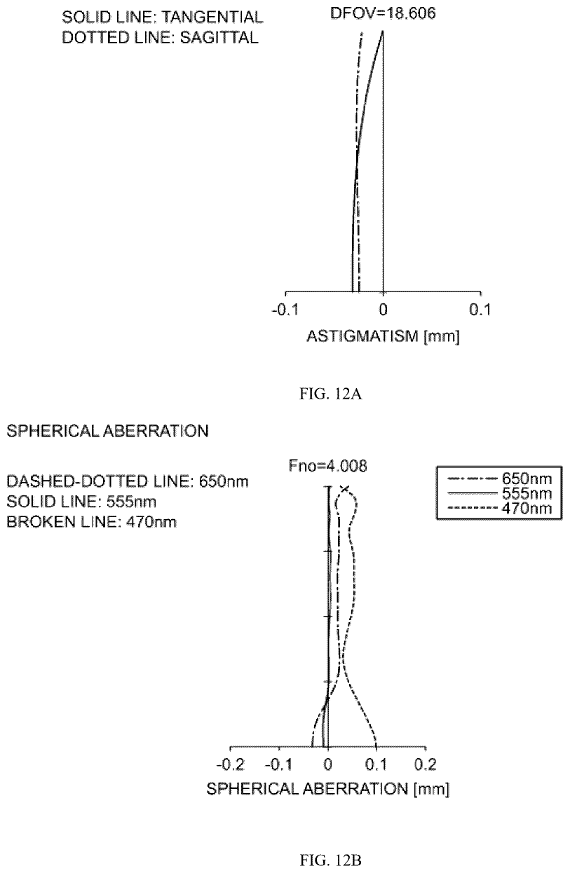

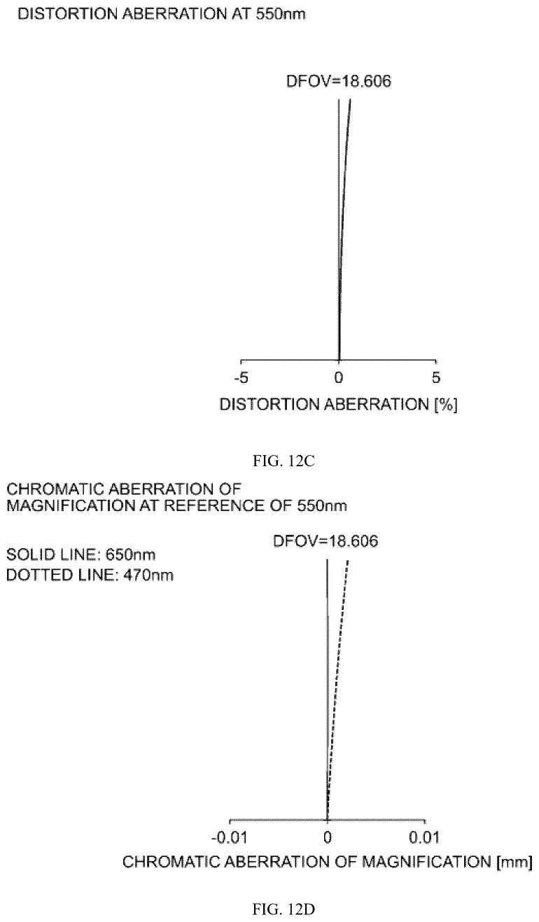

FIGS. 12A, 12B, 12C, and 12D are aberration diagrams illustrating the imaging lens 4 according to Example 4.

TABLE 13

| | SURFACE | | | | | | | | |
|---|---|---|---|---|---|---|---|---|---|
| | NUMBER | R | D | Nd | Vd | FOCAL LENGTH | | | |
| | 0 | INF | INF | | | | | | |
| | 1 | INF | 0.800 | | | | | | |
| DIAPHRAGM | STO | INF | −0.800 | | | | | | |
| L1 | 3 | 6.707 | 1.087 | 1.644 | 40.79 | 20.148 | 5.038 | 24.851 | f_F |
| | 4 | 13.034 | 0.050 | | | | | | |
| L2 | 5 | 7.320 | 1.329 | 1.544 | 56.33 | 6.107 | | | |
| | 6 | −5.684 | 0.050 | | | | | | |
| L3 | 7 | −31.869 | 0.426 | 1.588 | 28.27 | −24.635 | −4.588 | | f_B2 |
| | 8 | 26.507 | 0.185 | | | | | | |
| L4 | 9 | −5.694 | 0.420 | 1.567 | 37.56 | −5.734 | | | |
| | 10 | 7.733 | 0.810 | | | | | | |
| REFLECTIVE | 11 | INF | 7.256 | 1.517 | 64.17 | PRISM | | | 24.16 |
| LIGHT GUIDE | 12 | INF | 0.020 | | | | PRISM AIR GAP | | |
| ELEMENT 1 | | | | | | | | | |
| AIR LAYER 1001 | | | | | | | | | |
| REFLECTIVE | 13 | INF | 4.163 | 1.517 | 64.17 | | | | |
| LIGHT GUIDE | 14 | INF | 0.020 | | | | PRISM AIR GAP | | |
| ELEMENT 2 | | | | | | | | | |
| AIR LAYER 1001 | | | | | | | | | |
| REFLECTIVE | 15 | INF | 12.741 | 1.517 | 64.17 | | | | |
| LIGHT GUIDE | 16 | INF | 0.300 | | | | | | |
| ELEMENT 3 | | | | | | | | | |
| IR FILTER | 17 | INF | 0.210 | 1.517 | 64.17 | | | | |
| | 18 | INF | 0.612 | | | | | | |

In Table 13, data for “Surface number” of “11” to “15” is data of the reflective light guide element 33. “11” of “Surface number” is data corresponding to the prism 33a, and “12” is data of a prism air gap, that is, the first air layer 1001. Moreover, “13” of “Surface number” is data corresponding to the prism 33b, and “14” is data of a prism air gap, that is, the second air layer 1002. Then, “15” of “Surface number” is data corresponding to the prism 33c.

TABLE 14

| | SURFACE NUMBER | | | | | | | |
|---|---|---|---|---|---|---|---|---|
| | 3 | 4 | 5 | 6 | 7 | 8 | 9 | 10 |
| K | 0 | 0 | −17.580572 | −26.314209 | 99.000000 | 23.371628 | −61.464127 | 6.062295 |
| A4 | 0 | 0 | 5.842663.E−03 | 3.780842.E−02 | 5.428172.E−02 | 5.922074.E−02 | 8.074640.E−02 | 5.853574.E−02 |
| A6 | 0 | 0 | 9.314996.E−04 | −3.069093.E−02 | −5.088466.E−02 | −4.488906.E−02 | −5.275981.E−02 | −4.648889.E−02 |
| A8 | 0 | 0 | −8.571926.E−04 | 1.506872.E−02 | 2.263964.E−02 | 1.594587.E−02 | 2.667471.E−02 | 3.029559.E−02 |
| A10 | 0 | 0 | 3.678178.E−04 | −5.077545.E−03 | −6.643222.E−03 | −3.767486.E−03 | −1.132592.E−02 | −1.456321.E−02 |
| A12 | 0 | 0 | −9.786918.E−05 | 1.177218.E−03 | 1.416865.E−03 | 6.975638.E−04 | 3.453598.E−03 | 4.693640.E−03 |
| A14 | 0 | 0 | 1.635421.E−05 | −1.805193.E−04 | −2.148067.E−04 | −9.684613.E−05 | −6.868930.E−04 | −9.819769.E−04 |
| A16 | 0 | 0 | −1.644142.E−06 | 1.726478.E−05 | 2.136500.E−05 | 8.211110.E−06 | 8.382936.E−05 | 1.281070.E−04 |
| A18 | 0 | 0 | 8.991066E−08 | −9.270055E−07 | −1.223668E−06 | −2.872286E−07 | −5.687040E−06 | −9.482355E−06 |
| A20 | 0 | 0 | −2.041411E−09 | 2.128564E−08 | 3.024307E−08 | −1.106766E−09 | 1.643859E−07 | 3.043258E−07 |

TABLE 15

| | INF | |
|---|---|---|
| LTL | 29.678 | mm |
| da | 6.200 | mm |
| L | 4.356 | mm |
| EPD | 4.775 | mm |
| AREA1 | 2.037 | mm |
| PL_1 | 15.022 | mm |
| PL_2 | 13.040 | mm |
| PL_2′ | 14.074 | mm |
| P_margin | 0.948 | mm |
| DFOV | 18.606 | deg |
| dd | 4.096 | mm |
| EFL | 24.851 | mm |
| FNO | 4.008 | |
| f_B2 | −4.588 | mm |
| f_F | 5.038 | mm |
| f_B2/f_F | −0.911 | |
| EFL/dd | 6.067 | |
| EPD/PL | 0.197 | |
| EPD/Pref_d | 2.734 | |

TABLE 16
REFLECTIVE LIGHT GUIDE ELEMENT

| | INF | |
|---|---|---|
| Pref_d | 1.747 | mm |
| P_t | 3.430 | mm |
| θ | 30.0 | deg |
| P_od | 17.938 | mm |
| PRISM LENGTH PL | 24.200 | mm |
| PRISM CUT ANGLE | 18 | deg |
| (WITH REFERENCE TO LENS | | |
| OPTICAL AXIS) | | |

It turns out that each aberration is adjusted appropriately rom FIGS. 12A, 12B, 12C, and 12D. Moreover, when performing the settings of Table 13 to Table 16 for the imaging lens 4, “P_margin” illustrated in Table 15 is 0.948 mm. As described above, because “P_margin=PL_1-PL 2′>0” of the conditional expression is satisfied, manufacturing is possible even in the present configuration and the five-reflection configuration is implementable.

### Other Optical Functional Parts Configured as Reflective Light Guide Element

Next, various optical functional parts that can be used to guide the effective rays to the sensor surface will be described.

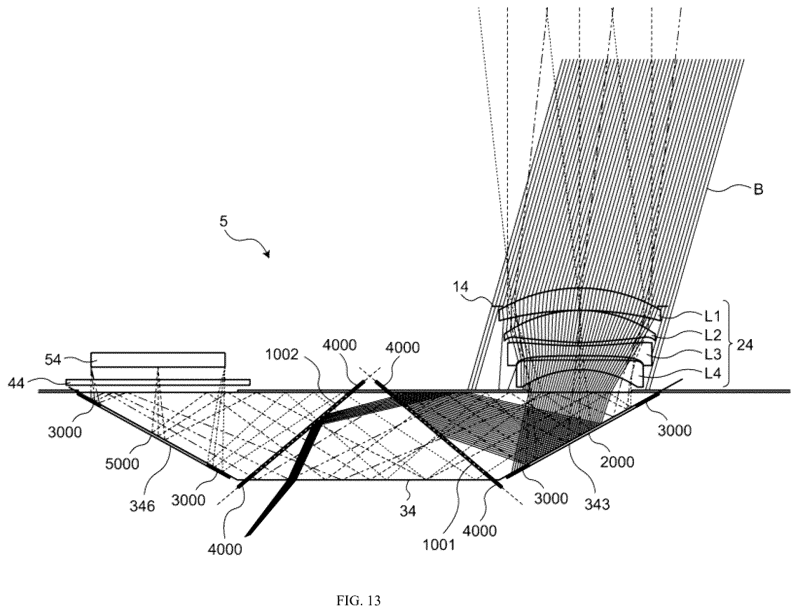

FIG. 13 is a diagram explaining an example of optical functional parts that can be configured as the reflective light guide element. An imaging lens 5 illustrated in FIG. 13 is a lens using the configuration of the imaging lens 4 illustrated in FIG. 9 as an example. The imaging lens 5 illustrated in FIG. 13 is illustrated with optical paths overlapped on the imaging lens, similar to FIG. 10.

A diaphragm 14, a lens group 24, an IR filter 44, and an imaging element 54 of the imaging lens 5 illustrated in FIG. 13 respectively correspond to the diaphragm 13, the lens group 23, the IR filter 43, and the imaging element 53 illustrated in FIG. 9. A reflective light guide element 34 illustrated in FIG. 13 is an example of configuring optical functional parts in the reflective light guide element 33 illustrated in FIG. 9.

An aluminum reflective coating 2000, a black absorbing coating 3000, a light shielding filter 4000, and a dichroic reflecting mirror 5000 illustrated in FIG. 13 are examples of the optical functional parts. In accordance with the shape etc. of the reflective light guide element, these optical functional parts may be selectively used.

In the reflective light guide element 34 illustrated in FIG. 13, the aluminum reflective coating 2000 is applied on the first slope 343. Moreover, the dichroic reflecting mirror 5000 is provided on the second slope 346. The dichroic reflecting mirror 5000 means an aluminum-enhanced reflection film with an incidence dependent film, and is one of the optical functional parts that changes a reflectance in accordance with the incident angle of rays.

Moreover, the black absorbing coating 3000 is applied around the aluminum reflective coating 2000, and unnecessary rays are cut by using the black absorbing coating 3000 like a mask. Furthermore, the black absorbing coating 3000 is applied also around the dichroic reflecting mirror 5000, and unnecessary rays are cut by using the black absorbing coating 3000 like a mask.

The black absorbing coating 3000 is an example of a low-reflection black absorber, and may be provided on a portion of the surface of the reflective light guide element 34 as appropriate.

Note that the coating can be provided by the conventional methods such as vacuum deposition and sputtering and these methods may be applied as appropriate.

Moreover, the light shielding filter 4000 is inserted into each end of the first air layer 1001 and the second air layer 1002 to cut unnecessary rays. The other low-reflection black absorber may be provided by coating etc. without being limited to the insertion of the light shielding filter 4000.

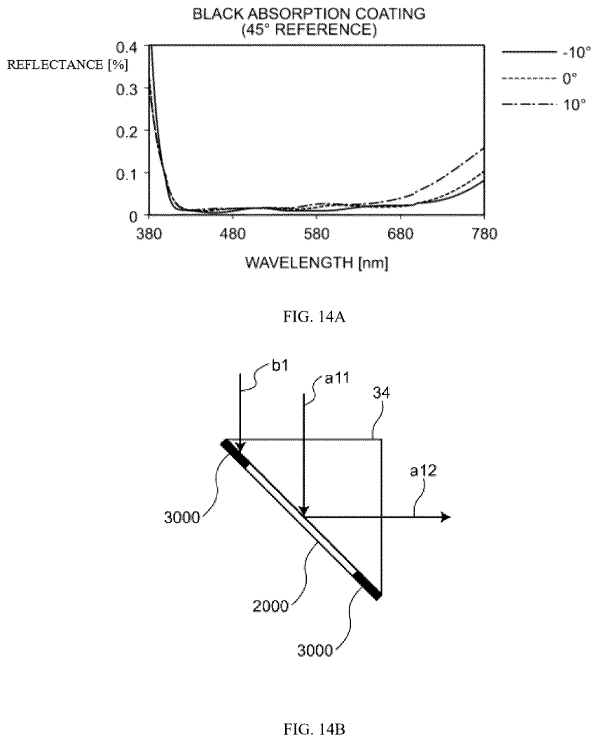

FIG. 14A is a diagram illustrating an example of wavelength characteristic of a reflectance of a low-reflection black absorption film. A black absorption coating that is an example of the low-reflection black absorption film illustrated in FIG. 14A has wavelength characteristic of a reflectance in the case of −10°, 0°, and 10° based on the incident angle of 45°. In the absorption coating illustrated in FIG. 14A, a reflectance takes a value close to 0% in substantially the entire area of the visible light area. For this reason, unnecessary light is reduced by using such the black absorption coating.

FIG. 14B is an explanatory diagram illustrating the black absorbing coating 3000 to be applied around the aluminum-enhanced reflection film. The black absorbing coating 3000 illustrated in FIG. 14B is formed around the aluminum-enhanced reflection film of the aluminum reflective coating 2000 by shifting from the optical axis and depositing a substance of the low-reflection black absorption film. When it is formed around the dichroic reflecting mirror 5000, the similar method is applied.

By shifting from the optical axis and depositing a substance of the low-reflection black absorption film as described above, an effective ray all illustrated as an example in FIG. 14B is reflected like a ray a12, and a ray b1 incident on a position more than a certain distance from the optical axis reaches a surface that cuts unnecessary rays.

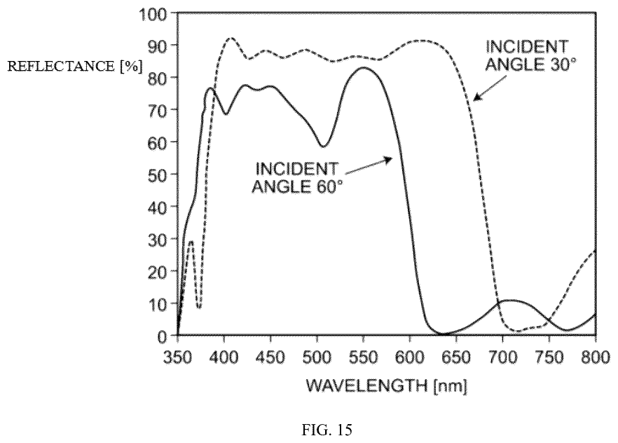

FIG. 15 is a diagram explaining wavelength characteristic of a reflectance of the incidence dependent film. In FIG. 15, in order to indicate a difference in wavelength characteristic according to an incident angle, an example of wavelength characteristic at the incident angle of 30° is illustrated with a dotted line, and an example of wavelength characteristic at the incident angle of 60° is illustrated with a solid line.

As illustrated in FIG. 15, among the incident ray with the incident angle of 30° and the incident ray with the incident angle of 60°, red is damped in the incident ray with the incident angle of 60°. For this reason, when providing the dichroic reflecting mirror 5000, it becomes hard to feel ghost light by the human eyes because red light decreases in accordance with an incident angle.

As described above, according to the first embodiment, five or more reflections can be performed by the same reflective light guide element. Moreover, because it is designed to perform five or more reflections in the same reflective light guide element, the imaging device can be applied to a body of a thinner imaging device by arranging the imaging element perpendicularly to the lens optical axis.

### Second Embodiment

Next, a configuration of an imaging device according to a second embodiment will be described. Note that an imaging device is explained below as a smartphone as an example but the imaging device is not limited to the smartphone. If the device is an imaging device, the device is also applicable to another form, for example, a tablet terminal, etc.

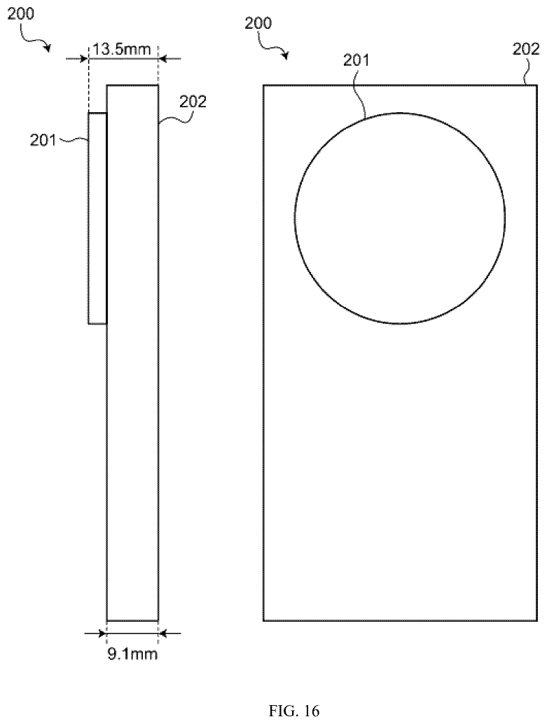

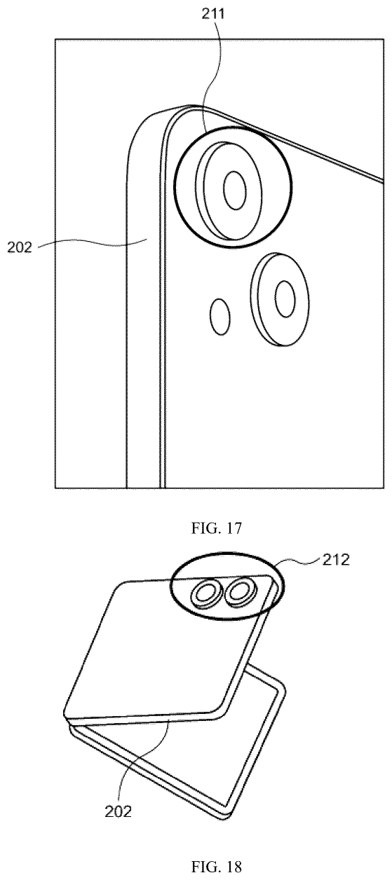

FIG. 16 is a diagram illustrating an example of the configuration of the imaging device according to the second embodiment. FIG. 16 illustrates an example of an exterior configuration of a smartphone 200 that is the imaging device according to the second embodiment.

FIG. 16 illustrates a right side view and a front view of the smartphone. The smartphone 200 includes a camera part 201 and a thin body 202. The smartphone 200 illustrated as an example has a thinned design that the camera part 201 has the thickness of 13.5 mm and the body 202 has the thickness of 9.1 mm, as illustrated in the right side view.

FIG. 17 is a diagram illustrating an example of a configuration of a camera of the camera part 201. The camera part 201 illustrated in FIG. 17 as an example is mounted with two cameras including a wide-angle camera and a telephoto camera. A lens housing 211 of the telephoto camera among lens housings of the two cameras is a lens housing of an imaging lens with the five-reflection configuration.

FIG. 18 is a diagram illustrating an example of a form of a bi-fold smartphone. Because the imaging lens with the five-reflection configuration can thin the thickness of the reflective light guide element, the imaging lens is also applicable to a bifold-type smartphone whose thickness of the body 202 is thin. As an example, two cameras are provided in the bifold-type smartphone illustrated in FIG. 18. One of two lens housings 212 is a wide-angle camera and the other is a telephoto camera.

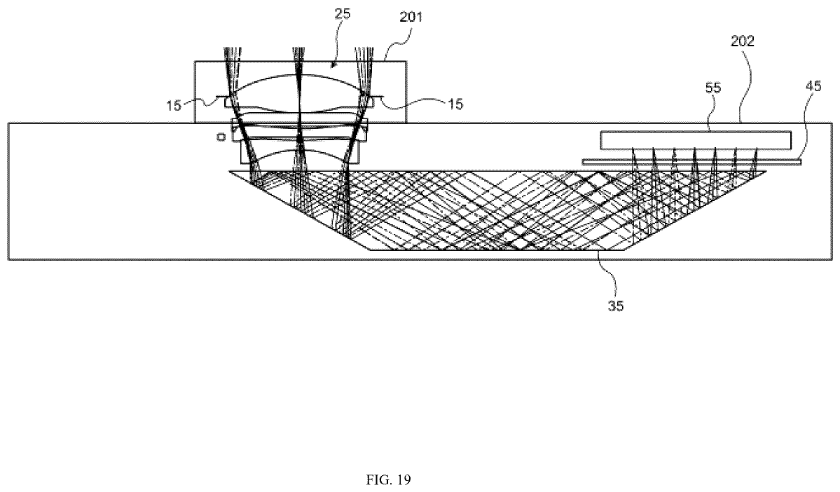

FIG. 19 is a diagram illustrating a mounting example of an imaging lens. A configuration of the imaging lens illustrated in FIG. 19 is an example of the configuration of an imaging lens with the five-reflection configuration. The imaging lens illustrated in FIG. 19 includes a diaphragm 15, a lens group 25, and a reflective light guide element 35, and the first plane of the reflective light guide element 35 is arranged to face an IR filter 45 and an imaging element 55. The light from the object side passes through the diaphragm 15, the lens group 25, and the reflective light guide element 35 in this order, and is emitted toward the IR filter 45.

The camera part 201 illustrated in FIG. 19 protrudes from the body 202. Because a portion of the lens group 25 protrudes from the body 202, the camera part 201 protrudes from the body 202. The VCM etc. for driving the lenses of the lens group 25 may be arranged in the camera part 201.

Moreover, for the sake of camera shake correction, a camera shake correction function of shifting the lens group 25 or shifting the imaging element 55 by using an appropriate actuator may be added.

Some of the lenses of the lens group 25 are housed inside the body 202. A space is formed by a depth of the housing part between the object-side surface (front surface) of the body 202 and the reflective light guide element 35 in the thickness direction of the body 202. The IR filter 45 and the imaging element 55 are arranged in the space. By such the arrangement, it is possible to thin the thickness of the camera part 201 and the thickness of the body 202.

Note that the shape of the reflective light guide element illustrated in the first embodiment, the second embodiment, etc. is an example. For example, the incident surface and the exit surface of the reflective light guide element are formed as a plane, but these surfaces are not limited to a plane. One or both of the incident surface and the exit surface may have a shape other than a plane. For example, these surfaces may be a slope surface or have the other shape. In that case, in accordance with the direction of the rays emitted from the exit surface, the IR filter and the imaging element are arranged.

As described above, the imaging device according to the second embodiment can make the body thinner. Moreover, by arranging the imaging element perpendicularly to the lens optical axis, it is possible to make the body thinner.

Explanation for Configuration that Value of “P_Margin” of Imaging Lens is Negative

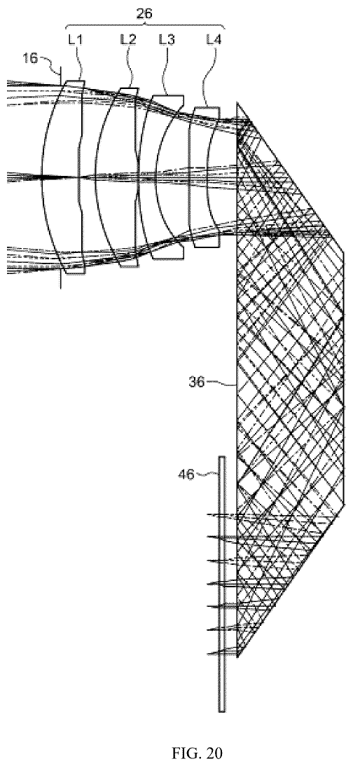

FIG. 20 is a diagram illustrating an example of an imaging lens having a configuration that the value of “P_margin” is negative. The imaging lens illustrated in FIG. 20 includes a diaphragm 16, a lens group 26, and a reflective light guide element 36. The light from the object side passes through the diaphragm 16, the lens group 26, and the reflective light guide element 36 in this order, and is emitted toward an IR filter 46. The optical settings of the imaging lens illustrated in FIG. 20 are indicated by Table 17 to Table 20.

TABLE 17

| | SURFACE | | | | | | | |
|---|---|---|---|---|---|---|---|---|
| | NUMBER | R | D | Nd | Vd | FOCAL LENGTH | | |
| | 0 | INF | INF | | | | | |
| | 1 | INF | 0.600 | | | | | |
| DIAPHRAGM | STO | INF | −0.600 | | | | | |
| L1 | 3 | 9.374 | 1.182 | 1.552 | 70.70 | 20.616 | 6.805 | 25.018 |
| | 4 | 51.181 | 0.418 | | | | | |
| L2 | 5 | 6.494 | 1.342 | 1.544 | 56.33 | 9.398 | | |
| | 6 | −22.171 | 0.077 | | | | | |
| L3 | 7 | 41.984 | 0.513 | 1.588 | 28.27 | −14.073 | −6.261 | |
| | 8 | 6.860 | 0.977 | | | | | |
| L4 | 9 | −18.937 | 0.557 | 1.544 | 56.33 | −12.197 | | |
| | 10 | 10.303 | 0.923 | | | | | |
| REFLECTIVE | 11 | INF | 21.784 | 1.517 | 64.17 | | | |
| LIGHT GUIDE | 12 | INF | 0.345 | | | | | |
| ELEMENT | | | | | | | | |
| IR GLASS | 13 | INF | 0.210 | 1.517 | 64.17 | | | |
| | 14 | INF | 0.350 | | | | | |
| | 15 | INF | 0.000 | | | | | |

TABLE 18

| | SURFACE NUMBER | | | | | | | |
|---|---|---|---|---|---|---|---|---|
| | 3 | 4 | 5 | 6 | 7 | 8 | 9 | 10 |
| K | 0 | 0 | 1.608958 | 42.615904 | 33.337820 | 2.603416 | −14.603471 | 13.363499 |
| A4 | 0 | 0 | 1.867232.E−04 | 1.401982.E−02 | 7.794578.E−03 | −5.692194.E−03 | 8.074579.E−03 | 8.297439.E−03 |
| A6 | 0 | 0 | −4.855731.E−04 | −8.678742.E−03 | −5.031233.E−03 | 5.246728.E−03 | 2.056804.E−03 | 5.638010.E−04 |
| A8 | 0 | 0 | 2.043357.E−04 | 3.489496.E−03 | 1.418863.E−03 | −3.867451.E−03 | −2.650854.E−03 | −1.760839.E−03 |
| A10 | 0 | 0 | −6.606235.E−05 | −8.745059.E−04 | −1.389882.E−05 | 1.958300.E−03 | 1.507251.E−03 | 1.105062.E−03 |
| A12 | 0 | 0 | 1.257015.E−05 | 1.440001.E−04 | −7.019341.E−05 | −5.770100.E−04 | −4.969489.E−04 | −4.078223.E−04 |
| A14 | 0 | 0 | −1.439535.E−06 | −1.596130.E−05 | 1.596675.E−05 | 1.030716.E−04 | 1.007158.E−04 | 9.301775.E−05 |
| A16 | 0 | 0 | 9.192240.E−08 | 1.159284.E−06 | −1.657341.E−06 | −1.118114.E−05 | −1.243415.E−05 | −1.297990.E−05 |
| A18 | 0 | 0 | −2.751939E−09 | −4.979747E−08 | 8.650398E−08 | 6.859341E−07 | 8.604577E−07 | 1.017347E−06 |
| A20 | 0 | 0 | 2.104945E−11 | 9.532041E−10 | −1.854150E−09 | −1.851530E−08 | −2.567744E−08 | −3.447967E−08 |

TABLE 19

| | INF | |
|---|---|---|
| LTL | 28.679 | mm |
| da | 7.100 | mm |
| L | 5.990 | mm |
| EPD | 5.279 | mm |
| AREA1 | 2.088 | mm |
| PL_1 | 12.676 | mm |
| PL_2 | 11.813 | mm |
| PL_2′ | 12.697 | mm |
| P_margin | −0.020 | mm |
| DFOV | 18.414 | deg |
| dd | 4.096 | mm |
| EFL | 25.018 | mm |
| FNO | 3.524 | |
| f_B2 | −6.261 | mm |
| f_F | 6.805 | mm |
| f_B2/f_F | −0.920 | |
| EFL/dd | 6.108 | |
| EPD/PL | 0.242 | |
| EPD/Pref_d | 3.281 | |

TABLE 20
REFLECTIVE LIGHT GUIDE ELEMENT

| | INF | |
|---|---|---|
| Pref_d | 1.609 | mm |
| P_t | 3.310 | mm |
| θ | 29.0 | deg |
| P_od | 15.745 | mm |
| PL: PRISM OPTICAL LENGTH | 21.784 | mm |

When using the optical settings illustrated in FIG. 20, a margin substantially disappears in the optical path of the third reflection in FIG. 20, and the value of “P_margin” becomes negative. In Table 19, “P_margin” is-0.020 mm to be negative.

As described above, in the case of setting that does not satisfy the conditional expression of “P_margin=PL_1-PL_2′>0”, the manufacturing of the five-reflection configuration may be difficult.

Comparison of Effect with Periscope Type

Next, a difference in effect with a periscope smartphone will be described.

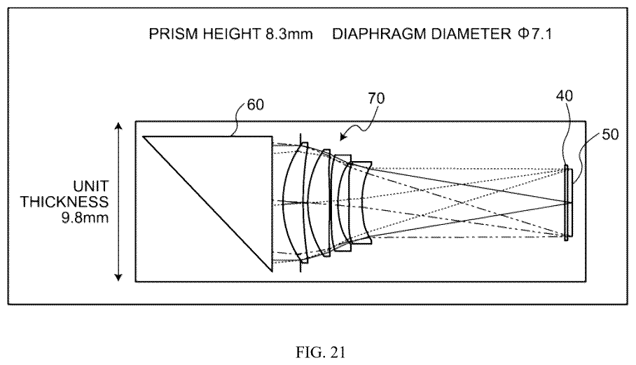

FIG. 21 is a diagram illustrating an example of a configuration of a smartphone mounted with a periscope lens. A periscope lens unit includes a single reflection prism 60 and a lens group 70. The periscope lens unit is arranged inside the smartphone to have a direction such that the optical axis of the lens group 70 becomes a direction orthogonal to the thickness direction of the smartphone. In other words, in the case of the periscope type, the height of the prism, the lens diameter of the lens unit, and the like affect the thickness of the smartphone.

For example, in the case of the normal periscope type of a tele lens of an image height 4 mm (½ inch) sensor and a 35 mm-converted focal length 131 mm of F-number 3.5, the diaphragm diameter is φ7.1. Because the height of the prism is about 8.3 mm and the thickness of the lens unit is about 9.8 mm, the lens cannot be housed in the body 202 of the thin smartphone having the thickness of 9.1 mm. Alternatively, an area of an electrical board mounted inside the smartphone is greatly occupied, and the size of the smartphone increases greatly.

On the other hand, compared with the periscope lens unit, because the present suggestion has a merit on the thickness as well as the length of the optical unit, it is possible to increase the volume for the board and the battery inside the smartphone.

Note that numerical values of a dimension of the smartphone illustrated in each drawing and numerical values of the other optical settings are illustrated only as an example and thus numerical values are not limited to only these values. The numerical values may be changed as appropriate without departing from the spirit of the inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An imaging lens comprising:
a lens group comprising at least one lens having optical power; and
a reflective light guide element having reflecting surfaces;
wherein the imaging lens is configured to enable light passing through the lens group to emit toward an imaging element after having n reflections on the reflecting surfaces, and n is an integer of 5 or more.

2. The imaging lens according to claim 1, wherein the reflective light guide element is provided with at least one medium on an optical path of light incident from the lens group, a refractive index of the at least one medium is smaller than a refractive index of a medium of the reflective light guide element.

3. The imaging lens according to claim 2, wherein the at least one medium is an air layer.

4. The imaging lens according to claim 2, wherein the reflective light guide element is provided with a first medium and a second medium on the optical path of light incident from the lens group, each of the first medium and the second medium having a refractive index different from the refractive index of the medium of the reflective light guide element.

5. The imaging lens according to claim 4, wherein the refractive index of the first medium and the refractive index of the second medium are smaller than the refractive index of the medium of the reflective light guide element.

6. The imaging lens according to claim 4, wherein the first medium and the second medium are diagonally provided with reference to a lens optical axis of the lens group at an angle at which a portion of the passing light is totally reflected, and extended lines of the first medium and the second medium intersect with each other.

7. The imaging lens according to claim 2, wherein a low-reflection black absorber of reducing or cutting passage of a portion of light is provided on at least an end of the at least one medium.

8. The imaging lens according to claim 2, wherein the at least one medium is provided with a glass material having a refractive index inside to cause total reflection of a portion of light.

9. The imaging lens according to claim 2, further comprising a light shielding filter inserted into each end of the at least one of medium to cut a portion of light.

10. The imaging lens according to claim 1, wherein the reflective light guide element is an optical system that is divided with an angle of 90°±30° with reference to rays inside the reflective light guide element that pass on a lens optical axis of the lens group and pass through the reflective light guide element.

11. The imaging lens according to claim 1, wherein the reflective light guide element causes light to be incident from the lens group and then emits the light reflected n times by the reflecting surfaces inside the reflective light guide element to a sensor surface of the imaging element that is arranged to a reflecting surface side on which an (n−1)th reflection is performed.

12. The imaging lens according to claim 1, wherein the reflective light guide element is configured to guide rays incident from an incident surface of the reflective light guide element to an exit surface of the reflective light guide element, the reflective light guide element is provided with a first slope, a first plane, a second plane, and a second slope; and
wherein the rays incident from the incident surface are reflected in order on the first slope, the first plane, the second plane, the first plane, and the second slope and then exit from the exit surface.

13. The imaging lens according to claim 12, wherein the first slope, the first plane, the second plane, and the second slope are provided at an angle at which the incident rays are totally reflected.

14. The imaging lens according to claim 12, wherein the incident surface and the exit surface are both located on the first plane.

15. The imaging lens according to claim 1, wherein at least one of the reflecting surfaces is a surface forming an outer shape of the reflective light guide element that is provided at an angle at which incident light is totally reflected.

16. The imaging lens according to claim 1, wherein the reflective light guide element has a reflecting surface whose portion is formed of reflective material.

17. The imaging lens according to claim 1, wherein the reflecting surface of the reflective light guide element has a dichroic mirror that changes a reflectance in accordance with an incident angle of the light.

18. The imaging lens according to claim 1, wherein the reflective light guide element has a low-reflection black absorber of reducing or cutting reflection of a portion of the light on a portion of a surface of the reflective light guide element.

19. The imaging lens according to claim 1, wherein the lens group comprises at least one lens having positive optical power and at least one lens having negative optical power.

20. The imaging lens according to claim 19, wherein in the lens group, a first lens through which the light from an object side passes first is a lens having positive optical power, and a final lens through which the light from the object side passes finally is a lens having negative optical power.

21. The imaging lens according to claim 1, wherein “4<EFL/dd”, in which “EFL” is a focal length of an entire lens and “dd” is a half size of a sensor surface of the imaging element in a diagonal direction, is satisfied.

22. The imaging lens according to claim 1, wherein “EPD/PL<0.24”, in which “EPD” is an exit pupil diameter and “PL” is an optical length of an optical path by which light passing on a lens optical axis of the lens group passes through the reflective light guide element, is satisfied.

23. The imaging lens according to claim 1, wherein among a plurality of rays of a ray bundle collected at a position distant from a lens optical axis of the lens group to form an image on a sensor surface of the imaging element, in a ray optical path of a first ray that is a ray passing through the imaging element side in the lens group, a margin is provided between a position at which an (n−2)th reflection is performed in the reflective light guide element and a surface on which an n-th reflection is performed.

24. The imaging lens according to claim 19, wherein
when the first ray is incident on the reflective light guide element, parallel to the lens optical axis of the lens group and is reflected n times inside the reflective light guide element,
$$AREA 1 = ( EPD / 2 ) / LTL * ( LTL - L ) ,$$
$$PL\_ 2 = AREA 1 + P\_t * TAN ( θ * 2 ) * ( n - 4 ) + ( AREA 1 * TAN θ + Pref\_d ) * TAN ( 2 * θ ) ,$$
$$L\_ 1 = P\_od - ( P\_t - Pref\_d ) / TAN θ ,$$
in which “EPD” is an exit pupil diameter, “LTL” is a lens total length, “L” is a distance from a lens vertex of a first lens of the lens group to the reflective light guide element, “P_t” is a thickness of the reflective light guide element in a lens optical axis direction, “Pref_d” is a distance from an incident surface of the reflective light guide element on which light from the lens group is incident to an intersection point at which the lens optical axis intersects with a first slope on which a first reflection is performed with the incident light, “0” is an angle between the incident surface of the reflective light guide element and a slope surface of the first slope, are satisfied,
when an incident angle of the first ray incident on the reflective light guide element has a deviation of 1° with the lens optical axis and is reflected n times (n is an integer of 5 or more) inside the reflective light guide element,
$$AREA 1 = ( EPD / 2 ) / LTL * ( LTL - L ) ,$$
$$PL\_ {2}^{′} = AREA 1 + P\_t * TAN ( ( θ * 1 ) * 2 ) * ( n - 4 ) + ( AREA 1 * TAN ( θ + 1 ) + Pref\_d ) * TAN ( 2 * ( θ + 1 ) ) ,$$
are satisfied, and
the margin is “PL_1-PL_2”,
PL_1-PL_2′>0.

25. The imaging lens according to claim 1, wherein “f_F>0”, in which “f_F” is a focal length of remaining lenses excepting a final lens and a lens just before the final lens in a passage order of the light from the object side among lenses comprised in the lens group, is satisfied.

26. The imaging lens according to claim 1, wherein “f_B2<0”, in which “f_B2” is a focal length of two lenses that are a final lens and a lens just before the final lens in a passage order of the light from the object side among lenses comprised in the lens group, is satisfied.

27. The imaging lens according to claim 1, wherein “−1.5<f_B2/f_F<−0.5”, in which “f_B2” is a focal length of two lenses that are a final lens and a lens just before the final lens in a passage order of the light from the object side among lenses comprised in the lens group and “f_F” is a focal length of remaining lenses excepting the final lens and the lens just before the final lens in the passage order of the light from the object side among lenses comprised in the lens group, is satisfied.

28. The imaging lens according to claim 1, wherein “L>P_t”, in which “L” is a distance from a lens vertex of a first lens of the lens group to the reflective light guide element and “P_t” is a thickness of the reflective light guide element in a lens optical axis direction, is satisfied.

29. The imaging lens according to claim 1, wherein “EPD/Pref_d<3.25”, in which “EPD” is an exit pupil diameter and “Pref_d” is a distance from an incident surface of the reflective light guide element on which light from the lens group is incident to an intersection point at which the lens optical axis intersects with a first slope on which a first reflection is performed with the incident light, is satisfied.

30. The imaging lens according to claim 1, wherein the number of the at least one lens having optical power in the lens group is four, the lens group comprises a first lens, a second lens, a third lens, and a fourth lens arranged in order of passage of light, the first lens and the second lens have positive optical power, and the third lens and the fourth lens have negative optical power.

31. The imaging lens according to claim 30, wherein a surface of an object side of the first lens is convex near an optical axis, a surface of an object side of the second lens and a surface of an image side of the second lens are convex near the optical axis, a surface of an object side of the third lens is concave near the optical axis, and a surface of an object side of the fourth lens and a surface of an image side of the fourth lens are concave near the optical axis.

32. The imaging lens according to claim 1, wherein the number of the at least one lens having optical power in the lens group is five, the lens group comprises a first lens, a second lens, a third lens, a fourth lens, and a fifth lens arranged in order of passage of light; the first lens has positive optical power, the second lens has negative optical power, the third lens has positive optical power, the fourth lens has negative optical power, and the fifth lens has negative optical power.

33. The imaging lens according to claim 32, wherein a surface of an object side of the first lens and a surface of an image side of the first lens are convex near an optical axis, a surface of an object side of the second lens and a surface of an image side of the second lens are concave near the optical axis, a surface of an object side of the third lens and a surface of an image side of the third lens are convex near the optical axis, a surface of an object side of the fourth lens and a surface of an image side of the fourth lens are concave near the optical axis, and a surface of an object side of the fifth lens and a surface of an image side of the fifth lens are concave near the optical axis.

34. An imaging device comprising:
an imaging lens comprising:
a lens group comprising at least one lens having optical power; and
a reflective light guide element having reflecting surfaces;
wherein the imaging lens is configured to enable light passing through the lens group to emit toward an imaging element after having n reflections on the reflecting surfaces, and n is an integer of 5 or more; and
the imaging element configured to capture an image of an object via the imaging lens.
